(19) United States
(12) Patent Application Publication
(10) Pub. No.: US 2011/0170784 A1
(43) Pub. Date: Jul. 14, 2011

(54) IMAGE REGISTRATION PROCESSING APPARATUS, REGION EXPANSION PROCESSING APPARATUS, AND IMAGE QUALITY IMPROVEMENT PROCESSING APPARATUS

(75) Inventors: Masayuki Tanaka, Tokyo (JP); Masatoshi Okutomi, Tokyo (JP); Yoichi Yaguchi, Tokyo (JP)

(73) Assignee: Tokyo Institute of Technology, Meguro-ku, Tokyo (JP)

(21) Appl. No.: 12/737,083

(22) PCT Filed: Mar. 12, 2009
(86) PCT No.: PCT/JP2009/055366

§ 371 Date: Mar. 21, 2011

(51) Int. Cl. G06K 9/46

(52) U.S. Cl. 382/195

(57) ABSTRACT

[Problem]An object of the present invention is to provide an image registration processing apparatus that is capable of performing a robust and high-accuracy registration processing with respect to an entire image between images including multiple motions.

[Means for Solving the Problem]The image registration processing apparatus according to the present invention comprises a feature point extraction processing unit that extracts feature points of a basis image and an input image that include multiple motions respectively, a feature point-based registration processing unit that performs a matching processing between basis image feature points and input image feature points and an initial motion parameter estimation processing after deleting outliers from matched feature points respectively, a single-motion region extraction processing unit that extracts a single-motion region based on an initial motion parameter and by using a similarity and a local displacement between images, a region-based registration processing unit that estimates a motion parameter with subpixel accuracy based on the initial motion parameter and the single-motion region, and a feature point deletion processing unit that deletes feature points included in the single-motion region from the basis image feature points and the input image feature points.

### TECHNICAL FIELD

The present invention relates to digital image processing technologies, and in particular to image registration processing technology that performs a robust and high-accuracy registration processing with respect to the entire image (the whole picture plane) between images including multiple motions and image quality improvement processing technology that utilizes the said image registration processing technology.

Further, the present invention relates to region expansion processing technology that performs a region expansion processing with respect to an image including multiple motions.

Moreover, the present invention relates to image quality improvement processing technology that utilizes the image registration processing technology of the present invention and the region expansion processing technology of the present invention.

### BACKGROUND ART

In digital image processing technologies, there is an image quality improvement processing that generates an image with high image quality by using multiple images. For example, super-resolution processing is one of such an image quality improvement processing. The super-resolution processing is a processing that reconstructs (estimates) one high-resolution image by using multiple low-resolution images with displacements.

In order to perform the image quality improvement processing that generates an image with high image quality by using multiple images, registration processing between these multiple images is absolutely necessary. In particular, in the super-resolution processing, a high-accuracy registration processing between multiple low-resolution images is necessary (see Non-Patent Document 1). Further, in various applications, performing the super-resolution processing with respect to the entire image (the whole picture plane) is requested.

However, it is often the case that multiple moving objects with different motions are included in photographed low-resolution images (observed images), performing a high-accuracy registration processing with respect to the entire image (the whole picture plane) between such images including multiple motions, is a very different problem.

As existing methods for performing the registration processing with respect to the entire image (the whole picture plane) between images including multiple motions (hereinafter referred to as “an image registration processing corresponding to multiple motions”), there are methods such as

(1) a method that performs the registration processing after assuming the entire image (the whole picture plane) as single motion (hereinafter referred to as “a conventional method 1”),
(2) a method that performs the registration processing with respect to each pixel by using only local information (see Non-Patent Document 2) (hereinafter referred to as “a conventional method 2”),
(3) a method that independently performs the registration processing with respect to each block after separating the entire image (the whole picture plane) into lattice-shaped blocks (see from Non-Patent Document 7 to Non-Patent Document 9) (hereinafter referred to as “a conventional method 3”),
(4) a method that simultaneously performs single-motion region extraction processing and the registration processing (see Non-Patent Document 10 and Non-Patent Document 11) (hereinafter referred to as “a conventional method 4”), and
(5) a method that extracts multiple motions by applying a feature point-based registration processing method (see from Non-Patent Document 12 to Non-Patent Document 14) (hereinafter referred to as “a conventional method 5”).

### THE LIST OF PRIOR ART DOCUMENTS

### Patent Documents

Patent Document 1: Japanese Patent Application Laid-open No. 2007-257287
Patent Document 2: Japanese Patent Application No. 2007-038006
Patent Document 3: Japanese Patent Application No. 2007-070401

### Non-Patent Documents

### Non-Patent Document 1:

S. Park, M. Park and M. Kang, “Super-resolution image reconstruction: a technical overview”, IEEE Signal Processing Magazine), Vol. 20, No. 3, pp. 21-36, (2003)

### Non-Patent Document 2:

W. Zhao and H. Sawhney, “Is super-resolution with optical flow feasible?”, European Conference on Computer Vision (ECCV), Vol. 1, pp. 599-613, (2002)

### Non-Patent Document 3:

Z. A. Ivanovski, L. Panovski and L. J. Karam, “Robust super-resolution based on pixel-level selectivity”, Proceedings of SPIE, Vol. 6077, pp. 607707, (2006)

### Non-Patent Document 4:

Masato Toda, Masato Tsukada and Akira Inoue, “Super-Resolution Considering Registration Error”, Proceeding of FIT 2006, Vol. 1, pp. 63-64, (2006)

### Non-Patent Document 5:

N. El-Yamany, P. Papamichalis and W. Schucany, “A Robust Image Super-resolution Scheme Based on Redescending M-Estimators and Information-Theoretic Divergence”, IEEE International Conference on Acoustics, Speech and Signal Processing (ICASSP), Vol. 1, pp. 741-744, (2007)

### Non-Patent Document 6:

S. Farsiu, M. Robinson, M. Elad and P. Milanfar, “Fast and robust multiframe super resolution”, IEEE Transactions on Image Processing, Vol. 13, No. 10, pp. 1327-1344, (2004)

### Non-Patent Document 7:

E. Courses and T. Surveys, “A Robust Iterative Super-Resolution Reconstruction of Image Sequences using a Lorentzian Bayesian Approach with Fast Affine Block-Based Registration”, IEEE International Conference on Image Processing (ICIP), Vol. 5, pp. 393-396, (2007)

### Non-Patent Document 8:

M. Irani, B. Rousso and S. Peleg, “Computing occluding and transparent motions”, International Journal of Computer Vision, Vol. 12, No. 1, pp. 5-16, (1994)

### Non-Patent Document 9:

M. Black and P. Anandan, “The robust estimation of multiple motions: Parametric and piecewise-smooth flow fields”, Computer Vision and Image Understanding, Vol. 63, No. 1, pp. 75-104, (1996)

### Non-Patent Document 10:

J. Wills, S. Agarwal and S. Belongie, “What went where”, IEEE

Computer Society Conference on Computer Vision and Pattern Recognition (CVPR), Vol. 1, pp. 37-44, (2003)

### Non-Patent Document 11:

P. Bhat, K. Zheng, N. Snayely, A. Agarwala, M. Agrawala, M. Cohenand B. Curless, “Piecewise Image Registration in the Presence of Multiple Large Motions”, IEEE Computer Society Conference on Computer Vision and Pattern Recognition (CVPR), Vol. 2, p. 2491-2497, 2006

### Non-Patent Document 12:

O. Chum and J. Matas, “Matching with PROSAC-progressive sample consensus”, IEEE Computer Society Conference on Computer Vision and Pattern Recognition (CVPR), Vol. 1, pp. 220-226, (2005)

### Non-Patent Document 13:

M. Fischler and R. Bolles, “Random sample consensus: a paradigm for model fitting with applications to image analysis and automated cartography”, Communications of the ACM, Vol. 24, No. 6, pp. 381-395, (1981)

### Non-Patent Document 14:

O. Choi, H. Kim and I. Kweon, “Simultaneous Plane Extraction and 2D Homography Estimation Using Local Feature Transformations”, Asian Conference on Computer Vision (ACCV), Vol. 4844, pp. 269-278, (2007)

### Non-Patent Document 15:

D. Lowe, “Distinctive Image Features from Scale-Invariant Keypoints”, International Journal of Computer Vision, Vol. 60, No. 2, pp. 91-110, (2004)

### Non-Patent Document 16:

Youichi Yaguchi, Masayuki Tanaka and Masatoshi Okutomi, “Robust Super-Resolution under Occlusion and Illumination Change”, The Special Interest Group Technical Reports of IPSJ: Computer Vision and Image Media, 2007-CVIM-159, Vol. 2007, No. 42, pp. 51-56, (2007)

### Non-Patent Document 17:

C. Sun, “Fast algorithms for stereo matching and motion estimation”, Proc. Of Australia-Japan Advanced Workshop on Computer Vision, pp. 38-48, (2003)

### Non-Patent Document 18:

S. Baker and I. Matthews, “Lucas-Kanade 20 Years On: A Unifying Framework”, International Journal of Computer Vision, Vol. 56, No. 3, pp. 221-255, (2004)

### Non-Patent Document 19:

Masayuki Tanaka and Masatoshi Okutomi, “A Fast Algorithm for MAP Super-resolution by Frequency-domain Optimization”, IPSJ Transactions on Computer Vision and Image Media, Vol. 47, SIG10 (CVIM15), pp. 12-22, (2006)

### SUMMARY OF THE INVENTION

### Problems to be Solved by the Invention

However, in the conventional method 1 that performs the registration processing after assuming that the entire image is single motion, despite actually multiple motions are included in the entire image, due to assuming that the entire image is single motion, there is a problem that accuracy of the registration processing is low and motion parameters with good accuracy cannot be obtained.

Further, in the conventional method 2 that performs the registration processing with respect to each pixel by using only local information, since only the local information is used in the registration processing, there is a problem that the registration processing easily becomes unstable.

Moreover, even in the conventional method 3 that independently performs the registration processing with respect to each block after separating the entire image into lattice-shaped blocks, similarly, since only information within a block (that is, only local information) is used in the registration processing with respect to each block, there is a problem that the registration processing easily becomes unstable. Further, although assuming that image within separated block is single motion and then performing the registration processing of that block, since it is not always true that the image within the separated block is single motion, depending on the separated block, there is also a problem that accuracy of the registration processing of that block is low and motion parameters with good accuracy cannot be obtained.

Further, in the conventional method 4 that simultaneously performs single-motion region extraction processing and the registration processing, although the single-motion region extraction processing and the registration processing are simultaneously performed, since extracting the single-motion region is the main purpose of the conventional method 4, it cannot be said that accuracy of the registration processing is so high, that is to say, there is a problem that motion parameters with accuracy that is necessary for the super-resolution processing (i.e. with subpixel accuracy) cannot be obtained.

In addition, in the conventional method 5 that that extracts multiple motions by applying the feature point-based registration processing method, only feature points corresponding to each motion can be obtained, there is a problem that a region corresponding to that motion cannot be obtained.

As described above, all of the above-described existing methods for performing the image registration processing corresponding to multiple motions (the conventional method 1˜the conventional method 5), are not methods suitable for the super-resolution processing.

By the way, recently, studies on “robust super-resolution processing” that is capable of robustly reconstructing an image based on results of the registration processing even the results of the registration processing are inaccurate, are also conducted (see from Non-Patent Document 2 to Non-Patent Document 7).

However, with respect to regions where the registration is inaccurate, even it is possible to reduce artifacts by the robust super-resolution processing, it is impossible to improve the resolution, therefore it does not become an essential solution.

That is to say, in order to perform the image quality improvement processing (for example, the super-resolution processing) with respect to the entire image (the whole picture plane) of an image including multiple motions, performing a robust and high-accuracy registration processing corresponding to multiple motions is required.

In other words, in order to perform the image registration processing corresponding to multiple motions, it is necessary to perform the extraction processing of “single-motion region” corresponding to each motion and the registration processing with respect to the extracted single-motion region, moreover, in order to perform the image quality improvement processing (for example, the super-resolution processing), it is necessary to perform the registration processing with subpixel accuracy with respect to the extracted single-motion region.

The present invention has been developed in view of the above-described circumstances, and an object of the present invention is to provide an image registration processing apparatus that is capable of performing a robust and high-accuracy registration processing with respect to the entire image (the whole picture plane) between images including multiple motions.

Further, another object of the present invention is to provide an image quality improvement processing apparatus that performs the registration processing with respect to multiple images including multiple motions by the image registration processing apparatus of the present invention, and then performs an image quality improvement processing by using the registration processing result and the multiple images.

Further, another object of the present invention is to provide a region expansion processing apparatus that performs a region expansion processing with respect to an image including multiple motions.

Moreover, another object of the present invention is to provide an image quality improvement processing apparatus that performs the registration processing with respect to multiple images including multiple motions by the image registration processing apparatus of the present invention, and then performs the region expansion processing based on the registration processing result with respect to the said multiple images by the region expansion processing apparatus of the present invention, and furthermore performs an image quality improvement processing by using the registration processing result, the region expansion result and the said multiple images.

### Means for Solving the Problems

The present invention relates to an image registration processing apparatus for performing a robust and high-accuracy registration processing of an entire image between a basis image including multiple motions and an input image including multiple motions, the above-described object of the present invention is effectively achieved by comprising: a feature point extraction processing unit; a feature point-based registration processing unit; a single-motion region extraction processing unit; a region-based registration processing unit; and a feature point deletion processing unit, wherein, said feature point extraction processing unit performs a feature point extraction processing that extracts feature points of said basis image and said input image respectively, said feature point-based registration processing unit performs a feature point-based registration processing that is comprised of a matching processing between feature points extracted from said basis image (basis image feature points) and feature points extracted from said input image (input image feature points) and an initial motion parameter estimation processing after deleting outliers from matched feature points, said single-motion region extraction processing unit performs a single-motion region extraction processing that extracts a single-motion region corresponding to an initial motion parameter outputted from said feature point-based registration processing unit based on said initial motion parameter and by using a similarity and a local displacement between images, said region-based registration processing unit performs a region-based registration processing that estimates a motion parameter corresponding to said single-motion region outputted from said single-motion region extraction processing unit with subpixel accuracy based on said initial motion parameter outputted from said feature point-based registration processing unit and said single-motion region, said feature point deletion processing unit performs a feature point deletion processing that deletes feature points included in said single-motion region extracted by said single-motion region extraction processing unit from said basis image feature points and said input image feature points.

Further, the above-described object of the present invention is more effectively achieved by that wherein by sequentially performing a processing performed in said feature point extraction processing unit, a processing performed in said feature point-based registration processing unit, a processing performed in said single-motion region extraction processing unit and a processing performed in said region-based registration processing unit based on said basis image and said input image, said image registration processing apparatus extracts a first single-motion region corresponding to a first dominant motion by using all feature points extracted by said feature point extraction processing unit, and estimates a first motion parameter corresponding to extracted said first single-motion region.

Further, the above-described object of the present invention is more effectively achieved by that wherein after said first motion parameter is estimated, by setting remaining feature points that are not deleted by said feature point deletion processing performed in said feature point deletion processing unit as said basis image feature points and said input image feature points that are used in said feature point-based registration processing performed in said feature point-based registration processing unit, and then once again sequentially performing said processing performed in said feature point-based registration processing unit, said processing performed in said single-motion region extraction processing unit and said processing performed in said region-based registration processing unit, said image registration processing apparatus extracts a second single-motion region corresponding to a second dominant motion, and estimates a second motion parameter corresponding to extracted said second single-motion region.

Further, the above-described object of the present invention is more effectively achieved by that wherein after said second motion parameter is estimated, said image registration processing apparatus sequentially extracts all single-motion regions corresponding to multiple motions and then sequentially estimates motion parameters corresponding to all sequentially-extracted single-motion regions by iteratively performing said processing performed in said feature point-based registration processing unit, said processing performed in said single-motion region extraction processing unit and said processing performed in said region-based registration processing unit, while removing feature points included in said single-motion region by said processing performed in said feature point deletion processing unit.

Moreover, the present invention relates to an image quality improvement processing apparatus for generating an image-quality-improved image with high image quality based on multiple images including multiple motions, the above-described object of the present invention is effectively achieved by comprising: an image registration processing unit; and an image quality improvement processing unit, wherein said image registration processing unit selects one basis image from said multiple images and sets all the remaining images as input images, next, extracts all single-motion regions within said multiple images including multiple motions by iteratively performing a registration processing of an entire image between one basis image and one input image that is performed by an image registration processing apparatus according to the present invention with respect to said multiple images, and then robustly estimates all motion parameters corresponding to said all single-motion regions with high accuracy, said image quality improvement processing unit generates said image-quality-improved image by performing an image quality improvement processing with respect to said multiple images based on multiple single-motion regions and multiple motion parameters corresponding to said multiple single-motion regions that are outputted from said image registration processing unit.

Furthermore, the present invention relates to an image registration processing apparatus for performing a robust and high-accuracy registration processing of an entire image between a basis image including multiple motions and an input image including multiple motions, the above-described object of the present invention is effectively achieved by comprising: a feature point extraction processing unit; a feature point-based registration processing unit; a single-motion region extraction processing unit; and a region-based registration processing unit, wherein said feature point extraction processing unit performs a feature point extraction processing that extracts feature points of said basis image and said input image respectively, said feature point-based registration processing unit performs a feature point-based registration processing that is comprised of a matching processing between feature points extracted from said basis image (basis image feature points) and feature points extracted from said input image (input image feature points) and an initial motion parameter estimation processing after deleting outliers from matched feature points, said single-motion region extraction processing unit performs a single-motion region extraction processing that extracts a single-motion region corresponding to an initial motion parameter outputted from said feature point-based registration processing unit based on said initial motion parameter and by using a similarity and a local displacement between images, said region-based registration processing unit performs a region-based registration processing that estimates a motion parameter corresponding to said single-motion region outputted from said single-motion region extraction processing unit with subpixel accuracy based on said initial motion parameter outputted from said feature point-based registration processing unit and said single-motion region; or by that wherein by sequentially performing a processing performed in said feature point extraction processing unit, a processing performed in said feature point-based registration processing unit, a processing performed in said single-motion region extraction processing unit and a processing performed in said region-based registration processing unit based on said basis image and said input image, said image registration processing apparatus extracts a first single-motion region corresponding to a first dominant motion by using all feature points extracted by said feature point extraction processing unit, and estimates a first motion parameter corresponding to extracted said first single-motion region.

Furthermore, the present invention relates to a region expansion processing apparatus for performing a region expansion processing that is performed with respect to a basis image including multiple motions and an input image including multiple motions based on said basis image, said input image, and multiple single-motion regions corresponding to multiple motions and multiple motion parameters corresponding to said multiple single-motion regions that are obtained by performing a registration processing of an entire image between said basis image and said input image, the above-described object of the present invention is effectively achieved by comprising: a textureless region extraction processing unit that inputs said basis image; an image deformation processing unit that inputs said input image and said multiple motion parameters; a similarity-based threshold processing unit that inputs said basis image as an input; a logical AND processing unit; and a logical OR processing unit that inputs said multiple single-motion regions, wherein said textureless region extraction processing unit performs a textureless region extraction processing that extracts a textureless region within said basis image and outputs extracted textureless region to said logical AND processing unit, said image deformation processing unit deforms said input image based on said multiple motion parameters and outputs said input image that is deformed to said similarity-based threshold processing unit as a deformed input image, said similarity-based threshold processing unit extracts a similar region by performing a threshold processing for a local similarity, with respect to said basis image and said deformed input image and outputs extracted similar region to said logical AND processing unit, said logical AND processing unit generates a textureless similar region by performing a logical AND processing with respect to said textureless region outputted from said textureless region extraction processing unit and said similar region outputted from said similarity-based threshold processing unit and outputs generated textureless similar region to said logical OR processing unit, said logical OR processing unit generates multiple expanded single-motion regions that merge said textureless similar region and said multiple single-motion regions by performing a logical OR processing with respect to said textureless similar region outputted from said logical AND processing unit and said multiple single-motion regions.

Furthermore, the above-described object of the present invention is more effectively achieved by that wherein said textureless region extraction processing obtains a local image variance of said basis image and extracts a region that obtained local image variance is less than or equal to a given threshold as a textureless region; or by that wherein said local similarity used in said similarity-based threshold processing unit is an SSD (Sum of Squared Difference) or an SAD (Sum of Absolute Difference).

Moreover, the present invention relates to an image quality improvement processing apparatus for generating an image-quality-improved image with high image quality based on multiple images including multiple motions, the above-described object of the present invention is effectively achieved by comprising: an image registration processing unit; a region expansion processing unit; and an image quality improvement processing unit, wherein said image registration processing unit selects one basis image from said multiple images and sets all the remaining images as input images, next, extracts all single-motion regions within said multiple images including multiple motions by iteratively performing a registration processing of an entire image between one basis image and one input image that is performed by an image registration processing apparatus according to the present invention with respect to said multiple images, and then robustly estimates all motion parameters corresponding to said all single-motion regions with high accuracy, based on all single-motion regions in said multiple images and all motion parameters corresponding to said all single-motion regions that are outputted from said image registration processing unit, said region expansion processing unit generates all expanded single-motion regions in said multiple images by iteratively performing a region expansion processing with respect to one basis image and one input image that is performed in a region expansion processing apparatus according to the present invention with respect to said multiple images, said image quality improvement processing unit generates said image-quality-improved image by performing an image quality improvement processing with respect to said multiple images based on all expanded single-motion regions in said multiple images that are outputted from said region expansion processing unit and said all motion parameters that are outputted from said image registration processing unit.

### Effects of the Invention

According to the image registration processing technology of the present invention, an advantageous effect that it is possible to perform a robust and high-accuracy registration processing with respect to the entire image between images including multiple motions, can be achieved.

Further, as to the registration processing between images that have large deformations and have no initial motions, although it is impossible to perform the said registration processing by conventional region-based registration processing algorithm, since the image registration processing technology of the present invention has both advantages of feature point-based registration processing and advantages of region-based registration processing, according to the present invention, it is also possible to perform such a difficult registration processing.

Further, since a lot of conventional registration processing methods assume single motion, actually in the case of applying such a registration processing method to applications such as the image processing, it is necessary for users of the applications to specify ion regions.

However, since the present invention estimates motion parameters while extracting single-motion regions, it is not necessary for users to specify single-motion regions.

Moreover, by using extracted multiple single-motion regions and estimated multiple motion parameters corresponding to these single-motion regions that are obtained by the image registration processing technology of the present invention, the image quality improvement processing apparatus according to the present invention realizes the super-resolution processing of the entire image (the whole picture plane).

According to the present invention, an advantageous effect that it is possible to reconstruct a high-resolution image from sequential images that multiple moving objects (motions) which move separately exist, can be achieved.

### BRIEF DESCRIPTION OF THE DRAWINGS

In the accompanying drawings:

FIG. 1 is a block diagram illustrating the first embodiment of an image quality improvement processing apparatus according to the present invention;

FIG. 2 is a block diagram illustrating an embodiment of an image registration processing apparatus according to the present invention;

FIG. 3 is a flow diagram showing a processing flow of an image registration processing apparatus 100 of the present invention;

FIG. 4 is a figure showing image examples in the case of performing a registration processing with respect to the entire image between two images including multiple motions by means of an image registration processing apparatus according to the present invention;

FIG. 5 is a figure showing sequential images obtained by photographing scenes that two moving objects move separately;

FIG. 6 is a figure showing results of single-motion region extraction processing;

FIG. 7 is a figure showing results obtained by deforming moving objects of the left side and the right side in conformity to a basis image;

FIG. 8 is a figure showing results of super-resolution processing;

FIG. 9 is a figure showing results of super-resolution processing;

FIG. 10 is a figure showing results of super-resolution processing;

FIG. 11 is a block diagram illustrating the second embodiment of an image quality improvement processing apparatus according to the present invention; and

FIG. 12 is a block diagram illustrating an embodiment of a region expansion processing apparatus according to the present invention.

### MODE FOR CARRYING OUT THE INVENTION

The present invention relates to image registration processing technology corresponding to multiple motions and image quality improvement processing technology that utilizes the said image registration processing technology.

Concretely, the present invention relates to an image registration processing apparatus, an image registration processing method and an image registration processing program that are capable of performing a robust and high-accuracy registration processing with respect to the entire image (the whole picture plane) between images including multiple motions.

Further, the present invention relates to an image quality improvement processing apparatus that generates an image-quality-improved image by performing a registration processing between images with respect to multiple images including multiple motions by means of the image registration processing apparatus of the present invention and performing an image quality improvement processing by using multiple single-motion regions and high-accuracy motion parameters corresponding to each single-motion region that are obtained by the registration processing and the multiple images.

Further, the present invention relates to region expansion processing technology that performs a region expansion processing with respect to an image including multiple motions. Moreover, the present invention relates to image quality improvement processing technology that utilizes the image registration processing technology of the present invention and the region expansion processing technology of the present invention.

Here, at first, the point aimed at of the present invention will be described.

The registration processing between images can be broadly divided into feature point-based registration processing and region-based registration processing.

Although the region-based registration processing requires given initial values of motion parameters and given single-motion regions, it is possible to perform the registration processing with high accuracy.

On the other hand, the feature point-based registration processing does not require initial values of motion parameters and single-motion regions, it is possible to robustly perform the registration processing.

However, the feature point-based registration processing cannot perform the registration processing with high accuracy that is the same as the region-based registration processing. Further, although the feature point-based registration processing can estimate motion parameters, it is impossible to estimate single-motion regions corresponding to the motion parameters.

Inventors of the present invention invent the present invention that is capable of performing a robust and high-accuracy registration processing with respect to the entire image (the whole picture plane) between images including multiple motions by aiming at advantages of the feature point-based registration processing and the region-based registration processing, combining advantages of both sides after eliminating disadvantages of both sides, and furthermore utilizing unique single-motion region extraction processing technology.

Hereinafter, embodiments of the present invention will be described in detail with reference to the drawings.

In order to perform the registration processing between images including multiple motions, the present invention estimates each motion as single motion, extracts a single-motion region corresponding to that single motion, and furthermore estimates motion parameters of extracted single-motion regions with high accuracy.

That is to say, in the case of performing a registration processing with respect to the entire image (the whole picture plane) between a basis image including multiple motions and an input image including multiple motions by using the present invention, at first, a feature point extraction processing (hereinafter also referred to as “the first processing”) that extracts feature points of the basis image and the input image respectively, is performed.

Next, a feature point-based registration processing (hereinafter also referred to as “the second processing”) that performs a matching processing between feature points extracted from the basis image (basis image feature points) and feature points extracted from the input image (input image feature points), deletes outliers from matched feature points, and robustly estimates an initial motion parameter, is performed. Hereinafter, the second processing is also referred to as “a feature point-based registration processing with outlier deletion”.

Next, a single-motion region extraction processing (hereinafter also referred to as “the third processing”) that extracts a region corresponding to estimated initial motion parameter (that is, a single-motion region) based on the estimated initial motion parameter and by using a similarity and a local displacement between images, is performed.

Next, a region-based registration processing (hereinafter also referred to as “the fourth processing”) that estimates a motion parameter corresponding to extracted single-motion region with subpixel accuracy (with high accuracy) based on the initial motion parameter and the extracted single-motion region, is performed.

In this way, by using all feature points extracted from the basis image and the input image and performing a series of processes from the first processing to the fourth processing, it is possible to extract a single-motion region corresponding to a dominant motion that includes the most feature points (hereinafter also referred to as “the first dominant motion”), and furthermore it is possible to estimate a motion parameter corresponding to that single-motion region.

That is to say, as described above, by performing the feature point-based registration processing with outlier deletion (the second processing) by using all feature points matched between images, the dominant motion that includes the most feature points can be estimated.

Next, a feature point deletion processing (hereinafter also referred to as “the fifth processing”) that deletes feature points included in the single-motion region from the basis image feature points and the input image feature points, is performed.

Next, by utilizing remaining feature points that are not deleted as the basis image feature points and the input image feature points and once again performing a series of processes from the second processing to the fourth processing, it is possible to extract a single-motion region corresponding to a motion that is the second most dominant motion (hereinafter also referred to as “the second dominant motion”), and furthermore it is possible to estimate a motion parameter corresponding to that single-motion region.

As described above, the present invention sequentially extracts single-motion regions corresponding to multiple motions and then sequentially estimates motion parameters corresponding to the sequentially-extracted single-motion regions by iteratively performing a series of processes from the second processing to the fourth processing, while removing feature points included in the single-motion region by performing the fifth processing. That is to say, the present invention sequentially estimates multiple motion parameters in order from the dominant motion that includes many feature points.

In this way, in the present invention, by performing the first processing and furthermore iteratively performing a series of processes from the second processing to the fifth processing, it is possible to extract multiple single-motion regions, and it is possible to robustly estimate the motion parameter corresponding to each single-motion region with high accuracy.

Incidentally, the above-described processes become the registration processing with respect to the entire image between two images including multiple motions. By iteratively applying the above-described processes (the registration processing with respect to the entire image between two images including multiple motions) to multiple images including multiple motions, the registration processing with respect to the entire image between multiple images including multiple motions becomes possible.

Moreover, the present invention generates an image-quality-improved image by performing the image quality improvement processing (for example, the super-resolution processing) of the entire image by using motion parameters estimated with high accuracy (i.e. with subpixel accuracy) by performing the registration processing of the entire image with respect to multiple images including multiple motions and single-motion regions corresponding to the motion parameters.

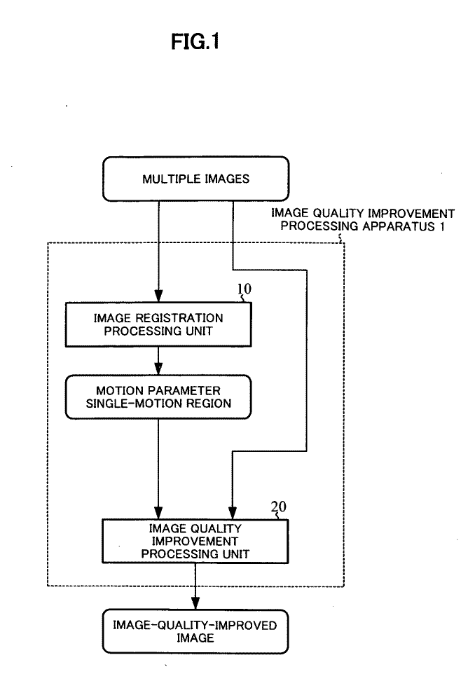

FIG. 1 is a block diagram illustrating the first embodiment of an image quality improvement processing apparatus according to the present invention.

As shown in FIG. 1, the image quality improvement processing apparatus 1 according to the present invention comprises an image registration processing unit 10 and an image quality improvement processing unit 20, and generates an image-quality-improved image with high image quality based on multiple images including multiple motions.

In the image quality improvement processing apparatus 1 of the present invention, at first, the image registration processing unit 10 extracts multiple single-motion regions corresponding to multiple motions by performing the registration processing of the entire image with respect to multiple images including multiple motions by means of an image registration processing apparatus according to the present invention that the details will hereinafter be described, and then robustly estimates a motion parameter corresponding to each extracted single-motion region with high accuracy.

That is to say, at first, the image registration processing unit 10 selects one basis image from multiple images including multiple motions and sets all the remaining images as input images. Next, the image registration processing unit 10 extracts all single-motion regions within multiple images including multiple motions by iteratively performing the registration processing of the entire image between one basis image and one input image that is performed by the image registration processing apparatus according to the present invention with respect to multiple images including multiple motions, and then robustly estimates all motion parameters corresponding to all single-motion regions with high accuracy.

Next, the image quality improvement processing unit 20 generates the image-quality-improved image by performing the image quality improvement processing with respect to multiple images including multiple motions based on multiple single-motion regions and multiple motion parameters corresponding to multiple single-motion regions that are outputted from the image registration processing unit 10. Further, it is possible to perform the image quality improvement processing that is performed in the image quality improvement processing unit 20 by using a method such as an image quality improvement processing method disclosed in Patent Document 3.

Moreover, as multiple images including multiple motions that are used in the image quality improvement processing apparatus according to the present invention, it is possible to use moving images with multiple motions (multiple complicated motions), that is, sequential images obtained by photographing scenes that multiple moving objects move separately. In such case, for example, it is possible to set the first frame of the sequential images as the basis image and set the subsequent frames as input images.

Of course, the image quality improvement processing apparatus of the present invention is not limited to being applied to moving images, obviously, it is also possible to use still images as multiple images including multiple motions.

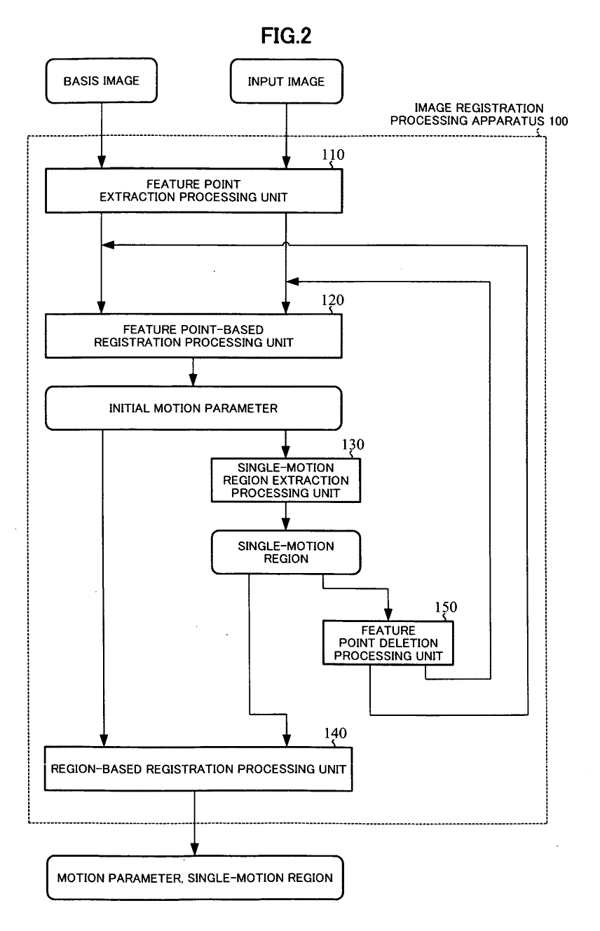

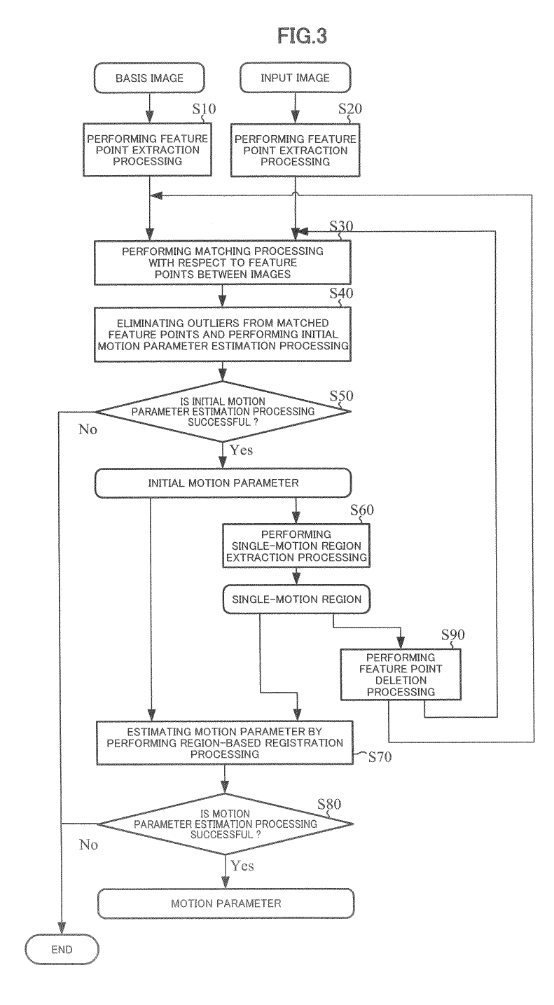

FIG. 2 is a block diagram illustrating an embodiment (an image registration processing apparatus 100) of an image registration processing apparatus according to the present invention. Further, FIG. 3 is a flow diagram showing a processing flow of the image registration processing apparatus 100 of the present invention. Hereinafter, the image registration processing apparatus according to the present invention will be described in detail by referring to FIG. 2 and FIG. 3.

The processing performed in the image registration processing apparatus according to the present invention is a registration processing of the entire image between two images including multiple motions.

As shown in FIG. 2, the image registration processing apparatus 100 according to the present invention comprises a feature point extraction processing unit 110, a feature point-based registration processing unit 120, a single-motion region extraction processing unit 130, a region-based registration processing unit 140 and a feature point deletion processing unit 150, and performs the registration processing of the entire image between two images including multiple motions (one of the two images is a basis image, and another of the two images is an input image).

As shown in FIG. 2, in the image registration processing apparatus 100 of the present invention, at first, the feature point extraction processing unit 110 performs a feature point extraction processing that extracts feature points of the basis image and the input image respectively based on the basis image and the input image (see step S10 and step S20 of FIG. 3).

Next, the feature point-based registration processing unit 120 performs a feature point-based registration processing. The feature point-based registration processing comprises a matching processing (see step S30 of FIG. 3) between feature points extracted from the basis image (basis image feature points) and feature points extracted from the input image (input image feature points) and an initial motion parameter estimation processing (see step S40 of FIG. 3) after deleting outliers from matched feature points.

Next, the single-motion region extraction processing unit 130 performs a single-motion region extraction processing (see step S60 of FIG. 3) that extracts a single-motion region corresponding to the initial motion parameter outputted from the feature point-based registration processing unit 120 based on the said initial motion parameter and by using a similarity and a local displacement between images.

Next, the region-based registration processing unit 140 performs a region-based registration processing (see step S70 of FIG. 3) that estimates a motion parameter corresponding to the single-motion region outputted from the single-motion region extraction processing unit 130 with subpixel accuracy (with high accuracy) based on the initial motion parameter outputted from the feature point-based registration processing unit 120 and the said single-motion region.

That is to say, the region-based registration processing unit 140 sets the initial motion parameter outputted from the feature point-based registration processing unit 120 as the initial value of the motion parameter, sets the single-motion region outputted from the single-motion region extraction processing unit 130 as a region of interest, and estimates a motion parameter corresponding to the said single-motion region (the region of interest) with subpixel accuracy.

At first, by sequentially performing the processing performed in the feature point extraction processing unit 110, the processing performed in the feature point-based registration processing unit 120, the processing performed in the single-motion region extraction processing unit 130 and the processing performed in the region-based registration processing unit 140 based on the basis image and the input image, the image registration processing apparatus 100 of the present invention extracts a single-motion region (hereinafter also referred to as “the first single-motion region”) corresponding to a dominant motion that includes the most feature points (the first dominant motion) by using all feature points extracted by the feature point extraction processing unit 110, and estimates a motion parameter (hereinafter also referred to as “the first motion parameter”) corresponding to the first single-motion region.

Next, the feature point deletion processing unit 150 performs a feature point deletion processing (see step S90 of FIG. 3) that deletes feature points included in the single-motion region extracted by the single-motion region extraction processing unit 130 from the basis image feature points and the input image feature points.

Next, by setting remaining feature points that are not deleted by the feature point deletion processing performed in the feature point deletion processing unit 150 as the basis image feature points and the input image feature points that are used in the feature point-based registration processing performed in the feature point-based registration processing unit 120, and then once again sequentially performing the processing performed in the feature point-based registration processing unit 120, the processing performed in the single-motion region extraction processing unit 130 and the processing performed in the region-based registration processing unit 140, the image registration processing apparatus 100 of the present invention extracts a single-motion region (hereinafter also referred to as “the second single-motion region”) corresponding to a motion that is the second most dominant motion (the second dominant motion), and estimates a motion parameter (hereinafter also referred to as “the second motion parameter”) corresponding to the second single-motion region.

As described above, the image registration processing apparatus 100 of the present invention sequentially extracts all single-motion regions corresponding to multiple motions and then sequentially estimates motion parameters corresponding to all sequentially-extracted single-motion regions by iteratively performing the processing performed in the feature point-based registration processing unit 120, the processing performed in the single-motion region extraction processing unit 130 and the processing performed in the region-based registration processing unit 140, while removing feature points included in the single-motion region by the processing performed in the feature point deletion processing unit 150.

In other words, the image registration processing apparatus 100 of the present invention sequentially extracts the single-motion region in order from the dominant motion that includes many feature points and then estimates the motion parameter corresponding to the single-motion region that is sequentially extracted in order.

In this way, in the image registration processing apparatus 100 of the present invention, by performing the feature point extraction processing performed in the feature point extraction processing unit 110 and furthermore iteratively performing the processing performed in the feature point-based registration processing unit 120, the processing performed in the single-motion region extraction processing unit 130, the processing performed in the region-based registration processing unit 140 and the processing performed in the feature point deletion processing unit 150, it is possible to extract multiple single-motion regions corresponding to multiple motions, and it is possible to robustly estimate the motion parameter corresponding to each single-motion region with high accuracy.

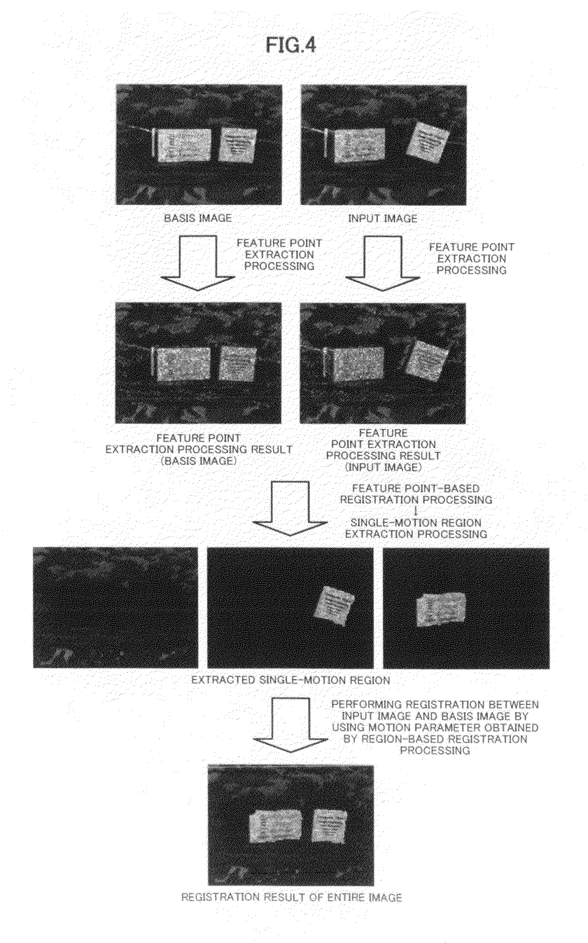

Hereinafter, each processing performed in the image registration processing apparatus of the present invention will be described in more detail by referring to the flow diagram of FIG. 3 and image examples of FIG. 4.

### <1> The Feature Point Extraction Processing

As shown in step S10 and step S20 of FIG. 3, the image registration processing apparatus of the present invention performs the feature point extraction processing with respect to the basis image including multiple motions and the input image including multiple motions respectively. Further, FIG. 4 show image examples of results of the feature point extraction processing performed with respect to the basis image and the input image.

The feature point extraction processing of the present invention, firstly computes Difference-of-Gaussian (DoG) while varying the scale parameter of Gaussian, and then extracts the minimum value or the maximum value of DoG as the feature point.

In this case, the scale parameter of DoG corresponding to the minimum value or the maximum value of DoG is utilized for normalizing the peripheral region of the extracted feature point in“the matching processing with respect to feature points between images” that will be described in <2a> in detail.

Here, setting positions of feature points extracted from the basis image as {(xₚ^{T},yₚ^{T})},p=1□N_{T}, and setting positions of feature points extracted from the input image as {(x_{q}^{I},y_{q}^{I})},q=1□N_{I}. Where, N_{T} represents the number of feature points extracted from the basis image, and N_{I} represents the number of feature points extracted from the input image.

### <2> The Feature Point-Based Registration Processing

In the image registration processing apparatus of the present invention, the feature point-based registration processing unit 120 performs the feature point-based registration processing based on the feature points extracted from the basis image (the basis image feature points) and the feature points extracted from the input image (the input image feature points).

Here, the outline of the feature point-based registration processing will be described.

The feature point-based registration processing comprises the matching processing between the basis image feature points and the input image feature points (that is, the matching processing with respect to feature points between images) and the initial motion parameter estimation processing after deleting outliers from the matched feature points.

“Deleting outliers from the matched feature points” to say here means deleting feature point pairs deviating from a given criteria (hereinafter also referred to as “deviation feature point pairs”) from feature point pairs obtained by the matching processing with respect to feature points between images (hereinafter also referred to as “matched feature point pairs”). Methods that estimate motion parameters while removing the deviation feature point pairs from the matched feature point pairs are described in Non-Patent Document 12˜Non-Patent Document 14.

In the image registration processing apparatus 100 of the present invention, with respect to “the feature point extraction processing” performed in the feature point extraction processing unit 110 and “the matching processing with respect to feature points between images (see step S30 of FIG. 3)” performed in the feature point-based registration processing unit 120, SIFT algorithm described in Non-Patent Document 15 is utilized. Moreover, the SIFT algorithm described in Non-Patent Document 15 is a method that relatively robust results can be obtained even in the case that deformations are large.

Further, with respect to “the initial motion parameter estimation processing after deleting outliers from the matched feature points (see step S40 of FIG. 3)” performed in the feature point-based registration processing unit 120, PROSAC algorithm described in Non-Patent Document 12 that is a fast method of RANSAC algorithm described in Non-Patent Document 13, is utilized.

In the present invention, by performing the feature point-based registration processing with deviation feature point pairs deletion (outlier deletion), it is possible to robustly estimate the initial motion parameter.

<2a> The Matching Processing with Respect to Feature Points Between Images

As shown in step S30 of FIG. 3, the image registration processing apparatus of the present invention performs a matching processing between the feature points extracted from the basis image (the basis image feature points) and the feature points extracted from the input image (the input image feature points), that is, the matching processing with respect to feature points between images.

The matching processing with respect to feature points between images according to the present invention comprises a processing for normalizing the peripheral region of the feature point, a processing for computing the feature descriptor of the feature point and a matching processing based on the distance of the feature descriptor.

In order to perform the processing for normalizing the peripheral region of the feature point, firstly, the scale parameter of the feature point and the direction of the feature point are determined. The scale parameter of DoG in the case that the feature point is extracted is used as the scale parameter of the feature point. Further, in order to determine the direction of the feature point, the direction of the gradient of each pixel of the peripheral region of the extracted feature point is computed, and then a histogram of the direction of the gradient that is computed is generated. The direction of the gradient of the pixel corresponding to the peak of the generated histogram is determined as the direction of the feature point.

Based on the scale parameter of the feature point and the direction of the feature point that are determined as described above, the peripheral region of the feature point is normalized. The processing for normalizing the peripheral region of the feature point is a processing that expands and/or reduces and/or rotates the peripheral region so that the scale and the direction become equal with respect to all the feature points.

Next, the peripheral region of the feature point that is normalized by the processing for normalizing the peripheral region of the feature point, is divided into small regions. As a concrete example, for example, the peripheral region of the feature point that is normalized is divided into 16 (4×4) small regions.

Next, in each divided small region, the direction of the gradient of each pixel is computed, and then a histogram of the direction of the gradient that is computed is generated. As a concrete example, for example, by generating the histogram after dividing a direction of 360 degrees by width of 45 degrees, frequency values of eight directions can be obtained. Values obtained by normalizing these frequency values with the number of pixels are set as the feature descriptor of the feature point.

Since in 16 divided small regions, the normalized frequency values of eight directions can be obtained respectively, with respect to one feature point, 128 feature descriptors can be obtained.

Here, the feature descriptor corresponding to a feature point (xₚ^{T},yₚ^{T}) extracted from the basis image is defined as dₚ^{T}. Further, the feature descriptor corresponding to a feature point (x_{q}^{I},y_{q}^{I}) extracted from the input image is defined as d_{q}^{I}. Where, dₚ^{T} and d_{q}^{I} are 128-dimension vectors that represent the feature descriptor.

In the matching processing based on the distance of the feature descriptor, firstly, a distance s_{pq} between the p-th feature point of the basis image and the q-th feature point of the input image is computed. The distance s_{pq} is computed based on s_{pq}=∥dₚ^{T}−d_{q}^{I}∥₂². Where, ∥·∥₂² represents an L2-Norm.

As a feature point of the input image corresponding to the p-th feature point of the basis image, the q-th feature point of the input image that the distance s_{pq} becomes smallest is chosen.

Next, a reliability r is computed based on r=s_{pq}²/s_{pq}¹. Where, s_{pq}¹ represents the smallest distance, and s_{pq}² represents the second smallest distance. Only in the case that the reliability r is larger than a threshold, the matching processing with respect to feature points between images is performed. As a concrete example, for example, the threshold of the reliability r is set to 1.5.

By performing a series of the above-described processes, the feature points extracted from the basis image and the feature points extracted from the input image are matched.

Here, a feature point extracted from the input image that is matched with a feature point (xₖ^{T},yₖ^{T}) extracted from the basis image is represented by (xₖ^{I},yₖ^{I}). Further, the number of the matched feature points is set to N_{TI}. That is to say, k=1˜N_{TI} holds.

<2b> The Initial Motion Parameter Estimation Processing After Deleting Outliers from the Matched Feature Points

As shown in step S40 of FIG. 3, the image registration processing apparatus of the present invention performs an initial motion parameter estimation processing after deleting outliers from the matched feature points.

Concretely, the initial motion parameter estimation processing after deleting outliers from the matched feature points is performed by the following step 1˜step 10.

Moreover, in the following embodiments, a projective transformation is used in a motion model, that is, the estimated initial motion parameter is a projective transformation parameter. However, the present invention is not limited to using a projective transformation in the motion model, for example, of course it is possible to use motion models except a projective transformation.

### Step 1:

With respect to t, n and L, given appropriate values are set respectively. Here, t=1, n=5 and L=0 are set.

### Step 2:

Correspondences of (n−1) feature points are chosen from a large reliability r, and of them, correspondences of three feature points are randomly chosen.

### Step 3:

By using correspondences between the chosen three feature points and a feature point that the reliability r is the n-th largest, a projective transformation parameter Hₜ is computed.

### Step 4:

Based on the projective transformation parameter Hₜ, the input image feature points are transformed, and a difference between the position of the transformed input image feature point and the position of the transformed basis image feature point matched with the input image feature point is computed. The number of feature points that the computed difference of the position is less than or equal to a given threshold, is counted. As a concrete example, for example, this given threshold is set to 2.

### Step 5:

In the case that the number of feature points that the difference of the position is less than or equal to a given threshold is larger than L, L is set to the number of feature points that the difference of the position is less than or equal to a given threshold.

### Step 6:

In the case that t satisfies a condition represented by the following Expression 1, the projective transformation parameter Hₜ is outputted as an estimate value H₀ of the initial motion parameter, and the initial motion parameter estimation processing ends (see step S50 of FIG. 3).

$$\begin{matrix}t > ( log η ) / log ( 1 - P ( L ) ) & [ Expression 1 ] \\ P ( L ) = {\prod }_{j = 0}^{3} \frac{L - j}{{N}_{TI} - j} & [ Expression 2 ]\end{matrix}$$

Where, η is a design parameter, as a concrete example, for example, η is set to 0.05.

### Step 7:

t is incremented by one.

### Step 8:

In the case that t exceeds a given number τ, as a thing that the initial motion parameter estimation processing is failed, the processing of the image registration processing apparatus of the present invention is terminated (see step S50 of FIG. 3). As a concrete example, for example, τ is set to 1000000.

### Step 9:

In the case that t satisfies a condition represented by the following Expression 3, n is incremented by one.

$$t > τ \times \frac{{}_{n}^{}{C}{}_{3}^{}}{{}_{{N}_{TI}}^{}{C}{}_{3}^{}} \qquad [ Expression 3 ]$$

### Step 10:

Returning to step 2, the processing is iterated.

### <3> The Single-Motion Region Extraction Processing

In the image registration processing apparatus of the present invention, with respect to “the single-motion region extraction processing” performed in the single-motion region extraction processing unit 130, pixel selection algorithms disclosed in Non-Patent Document 2 and Non-Patent Document 16 are utilized.

That is to say, the single-motion region extraction processing unit 130 selects pixels by using the pixel selection algorithms disclosed in Non-Patent Document 2 and Non-Patent Document 16, and then extracts a region that is comprised of only selected pixels (that is, an assembly of the selected pixels) as a single-motion region.

In Non-Patent Document 2 and Non-Patent Document 16, when selecting pixels, in addition to an evaluation based on a similarity between images, a local displacement is utilized. In the present invention, in the case of using the algorithm described in Non-Patent Document 16, pixels that the similarity between images is high and the displacement is small are selected. The selected pixels are set as pixels belonging to a single-motion region.

Moreover, the present invention is not limited to performing the single-motion region extraction processing by using the pixel selection algorithms disclosed in Non-Patent Document 2 and Non-Patent Document 16 in the single-motion region extraction processing unit 130, for example, of course it is also possible to generate a mask image by using a mask image generation algorithm disclosed in Non-Patent Document 1 and extract the generated mask image as a single-motion region.

As shown in step S60 of FIG. 3, the image registration processing apparatus of the present invention performs the single-motion region extraction processing that extracts a single-motion region corresponding to the estimated initial motion parameter based on the said initial motion parameter and by using the similarity and the local displacement between images. Further, FIG. 4 shows image examples of the extracted single-motion region.

Hereinafter, a preferred embodiment of the single-motion region extraction processing will be concretely described.

In the single-motion region extraction processing of the present invention, from the basis image T, the input image I and the estimated initial motion parameter H₀ (hereinafter, simply also referred to as the initial motion parameter H₀), a region in a corresponding input image is extracted as a mask image M.

Here, the mask image M represents a single-motion region. Further, an image obtained by deforming the basis image T with the initial motion parameter H₀ is defined as a deformed basis image T′.

At first, a similarity R (x,y;i,j) in position (x,y) between the deformed basis image T′ and the input image I is defined as the following Expression 4.

$$R ( x , y , ; i , j ) = \frac{ \begin{matrix}{\sum }_{- w \leq u \leq w , - w \leq v \leq w} \\ {T}^{′} ( x + u + i , y + v + j ) I ( x + u , y + v )\end{matrix}}{\sqrt{\begin{matrix}{\sum }_{- w \leq u \leq w , - w \leq v \leq w} \\ {{T}^{′} ( x + u + i , y + v + j )}^{2} \times \\ {\sum }_{- w \leq u \leq w , - w \leq v \leq w} {I ( x + u , y + v )}^{2}\end{matrix}}} \qquad [ Expression 4 ]$$

Where, w represents the size of the peripheral region. In this embodiment, w is set to 7.

Next, by using nine values of the similarity R(x,y;i,j) in i=−1, 0, 1 and j=−1, 0, 1, a value in position (x,y) of the mask image M that represents the single-motion region, that is, M(x,y) is set as below.

At first, by using the nine values of the similarity R(x,y;i,j) and performing fitting with a quadratic function represented by the following Expression 5, six coefficients Cₐ, C_{b}, C_{c}, C_{d}, Cₑ and C_{f} are obtained.

\hat{R}(i,j)=Cₐi²+C_{b}ij+C_{c}j²+C_{d}i+Cₑj+C_{f} [Expression 5]

Next, with respect to the obtained six coefficients Cₐ, C_{b}, C_{c}, C_{d}, Cₑ and C_{f}, in the case that all of relations that are represented by the following Expressions 6, 7, 8 and 9 hold, M(x,y) is set to 1. And then, in the case that even one of the relations that are represented by the following Expressions 6, 7, 8 and 9 does not hold, M(x,y) is set to 0.

$$\begin{matrix}{C}_{a} < 0 , {C}_{c} < 0 , D < 0 & [ Expression 6 ] \\ \vert \frac{2 {C}_{c} {C}_{d} - {C}_{b} {C}_{e}}{D} \vert < 0.5 & [ Expression 7 ] \\ \vert \frac{2 {C}_{a} {C}_{e} - {C}_{b} {C}_{d}}{D} \vert < 0.5 & [ Expression 8 ] \\ \frac{{C}_{e} {C}_{e}^{2} + {C}_{c} {C}_{d}^{2}}{D} + {C}_{f} > {R}_{th} & [ Expression 9 ]\end{matrix}$$

Where, D=C_{b}²−4CₐC_{c} holds and Rₜₕ is a design parameter. In this embodiment, Rₜₕ is set to 0.9925.

By iterating the above computation processing with respect to all positions (x,y), it is possible to compute (extract) the mask image M(x,y) that represents the single-motion region.

### <4> The Region-Based Registration Processing

In the image registration processing apparatus of the present invention, with respect to the region-based registration processing performed in the region-based registration processing unit 140, ICIA algorithm described in Non-Patent Document 18 is utilized. The ICIA algorithm is an algorithm that is capable of performing the registration processing at high speed and with high accuracy.

As shown in step S70 of FIG. 3, the image registration processing apparatus of the present invention performs the region-based registration processing that estimates a motion parameter corresponding to the extracted single-motion region with subpixel accuracy (with high accuracy) based on the robustly-estimated initial motion parameter and the said single-motion region. Further, FIG. 4 show image examples of results of performing the registration processing of the entire image between the basis image and the input image by using the motion parameter obtained by the region-based registration processing.

Hereinafter, a preferred embodiment of the region-based registration processing according to the present invention will be concretely described.

The region-based registration processing of the present invention estimates a motion parameter H₁ with high accuracy so as to minimize an evaluation function represented by the following Expression 10.

$${E}_{0} ( {H}_{1} ) = {\sum }_{x , y} M ( x , y ) [ T ( x , y ) - {I ( {w}_{x} ( x , y , {H}_{1} ) , {w}_{y} ( x , y , {H}_{1} ) ]}^{2} \qquad [ Expression 10 ]$$

Where, M′(x,y) represents a mask image obtained by deforming the single-motion region M(x,y) based on the initial motion parameter H₀.

Further, wₓ(x,y;H₁) represents x-coordinate after converting with the motion parameter H₁. w_{y}(x,y;H₁) represents y-coordinate after converting with the motion parameter H₁.

In order to minimize the evaluation function represented by the above Expression 10, a gradient-based minimization method is utilized. Although the gradient-based minimization method requires an initial value, the initial motion parameter H₀ is used as that initial value.

The motion parameter H₁ obtained by minimizing the evaluation function represented by Expression 10 is outputted, and the region-based registration processing ends (see step S80 of FIG. 3).

On the other hand, in the case that minimizing the evaluation function represented by Expression 10 by means of the minimization method fails, as a thing that the motion parameter estimation processing is failed, the processing of the image registration processing apparatus of the present invention is terminated (see step S80 of FIG. 3).

### <5> The Image Quality Improvement Processing

In the image quality improvement processing apparatus 1, the image quality improvement processing unit 20 generates the image-quality-improved image by performing the image quality improvement processing with respect to multiple images including multiple motions based on multiple single-motion regions and multiple motion parameters corresponding to multiple single-motion regions that are outputted from the image registration processing unit 10.

Hereinafter, a preferred embodiment of the image quality improvement processing of the present invention will be concretely described.

N images are observed (photographed), and then Mₖ motion parameters (the projective transformation parameter) Hₖₗ and a mask image Mₖₗ that represents a single-motion region corresponding to the motion parameter are obtained from each observed image by the registration processing of the entire image performed in the image registration processing unit 10.

In this case, in the image quality improvement processing unit 20, by minimizing an evaluation function represented by the following Expression 11, the image quality improvement processing is performed.

$${E}_{1} ( h ) = {\sum }_{k = 1}^{N} {\sum }_{l = 1}^{{M}_{k}} {( {A}_{kl} h - {f}_{k} )}^{T} diag ( {m}_{kl} ) ( {A}_{kl} h - {f}_{k} ) + λ {‖ Qh ‖}_{2}^{2} \qquad [ Expression 11 ]$$

Where, h represents a vector representation of the image-quality-improved image. fₖ represents a vector representation of the k-th observed image. mₖₗ represents a vector representation of a mask image that represents a single-motion region corresponding to the 1-th motion parameter (the projective transformation parameter) of the k-th observed image. N is the number of the observed images.

Further, Aₖₗ represents a matrix for estimating the k-th observed image from the image-quality-improved image obtained from the 1-th motion parameter (the projective transformation parameter) of the k-th observed image and a camera model. Q represents restraints of the image-quality-improved image. X represents a parameter that denotes the size of the restraints. diag(mₖₗ) represents a diagonal matrix with diagonal elements mₖₗ. T denotes a transposition operator of a matrix.

The image registration processing apparatus and the image quality improvement processing apparatus according to the present invention can be implemented by using a computer system and software (computer programs), and then, of course can also be implemented by hardware such as an ASIC (Application Specific Integrated Circuit), a GPU (Graphics Processing Unit) and an FPGA (Field Programmable Gate Array).

Hereinafter, by applying the image registration processing technology of the present invention with respect to sequential images (real images) obtained by photographing complicated real scenes that multiple moving objects exist and phenomena such as occlusions and specular reflections occur and furthermore performing the super-resolution processing based on results of the image registration processing according to the present invention, the effectiveness of the present invention is verified. As a result, it is confirmed that the resolution of the entire image is effectively improved.

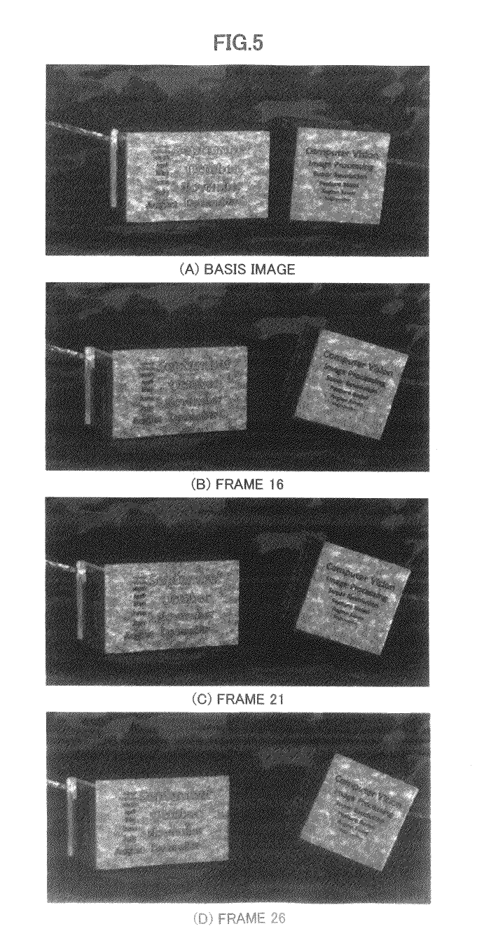

FIG. 5 shows sequential images obtained by photographing scenes that two moving objects move separately. With respect to the sequential images shown in FIG. 5, the registration processing of the entire image according to the present invention is performed. As the single motion of the present invention, a planar projective transformation is assumed. The planar projective transformation is an image deformation that represents single planar motion.

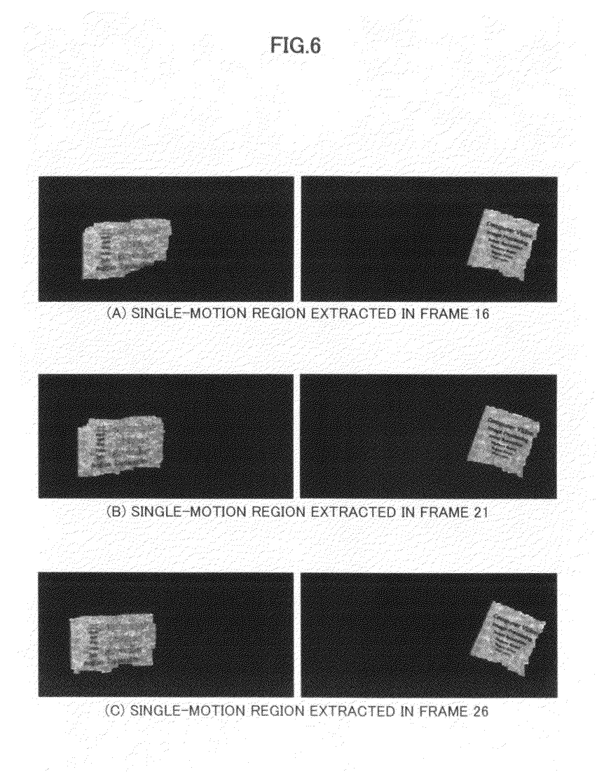

FIG. 6 shows results of the single-motion region extraction processing. The left side of FIG. 6 is extraction results of the left single-motion region, and the right side of FIG. 6 is extraction results of the right single-motion region. From FIG. 6, it is clear that only the single-motion region is accurately extracted. It must be noted that it is not necessary to extract all pixels within the moving object. Since performing the image quality improvement processing (for example, the super-resolution processing) is also the purpose of the present invention, extracting only pixels that are accurately registered with subpixel accuracy, is more significant.

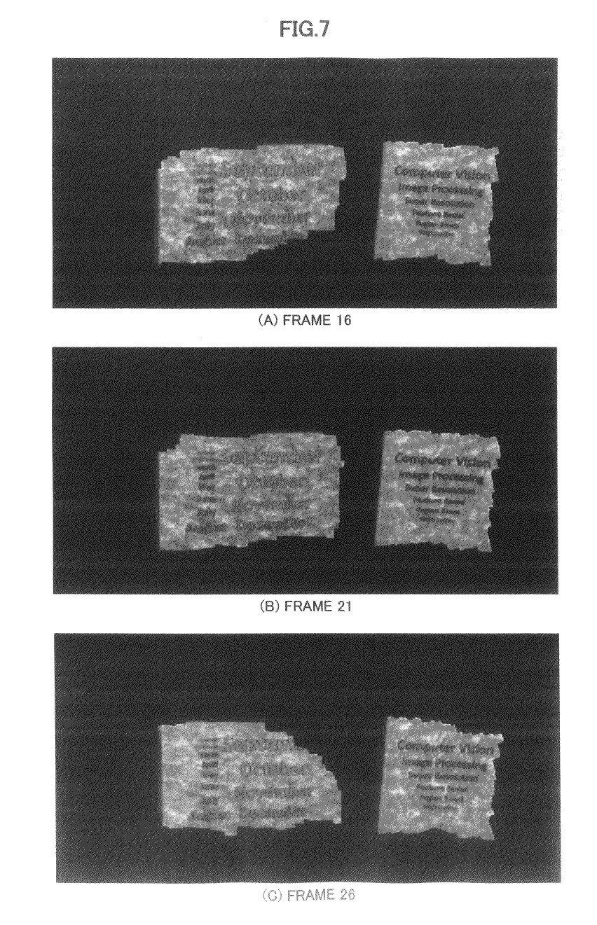

FIG. 7 shows results obtained by deforming moving objects of the left side and the right side in conformity to the basis image. By comparison with FIG. 5(A), being accurately registered with the basis image is clear.

Next, by using the motion parameter estimated by the present invention, the super-resolution processing is performed. Further, for comparison, the super-resolution processing is also performed by using the motion parameter estimated by the density gradient method. Three types of regions, i.e. the entire image (the whole picture plane), the manually-specified left moving object and the manually-specified right moving object are used as the processing region of the density gradient method. In the density gradient method, as the motion, a planar projective transformation is assumed. As the robust super-resolution processing, by using only the region corresponding to the motion obtained by the method described in Non-Patent Document 16, the super-resolution processing is performed. The number of frames of the observed images is 30. A method described in Non-Patent Document 19 is used as the reconstruction method, and with respect to the magnification of the high resolutionization, both the magnification in horizontal dimension and the magnification in vertical dimension are set to 3 times.

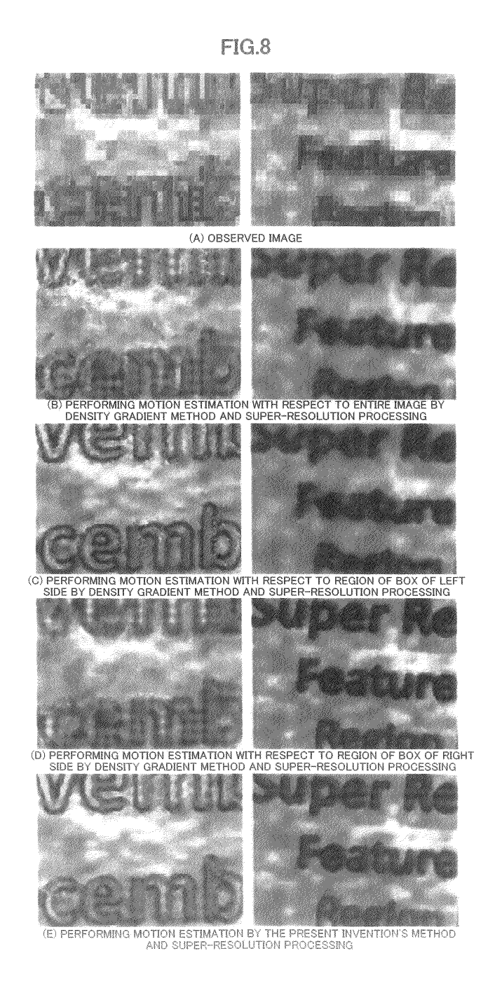

FIG. 8 shows results of the super-resolution processing. At first, due to the effect of the above-described robust super-resolution processing, it is clear that there is no image degradation in all of the super-resolution processing results of FIG. 8. Although the robust super-resolution processing has an effect that suppresses the image degradation, the robust super-resolution processing cannot improve the resolution of a region that the registration is inaccurate. It is clear that the resolutions of the left side of FIG. 8(C), the right side of FIG. 8(D), the left side of FIG. 8(E) and the right side of FIG. 8(E) are improved by comparison with other super-resolution processing results of FIG. 8. Regions that the resolution is improved are regions that the registration is accurate. From this result, it is clear that the registration of the moving object is accurately performed by the registration processing with respect to the entire image between images including multiple motions according to the present invention.

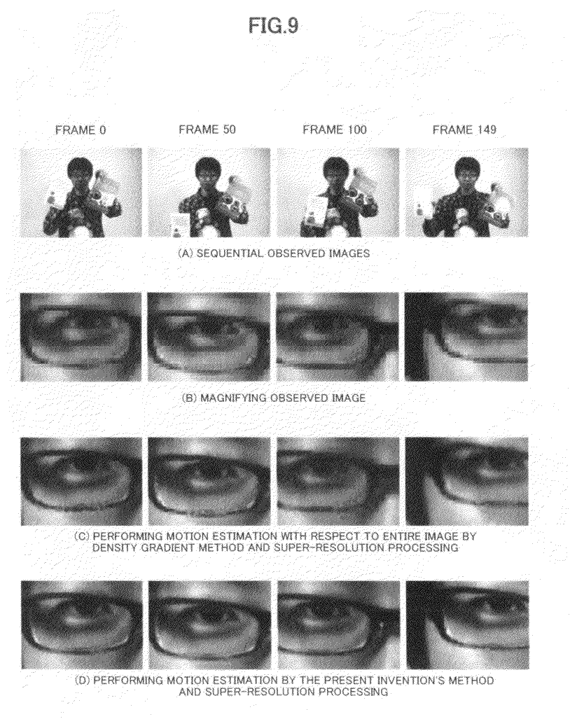

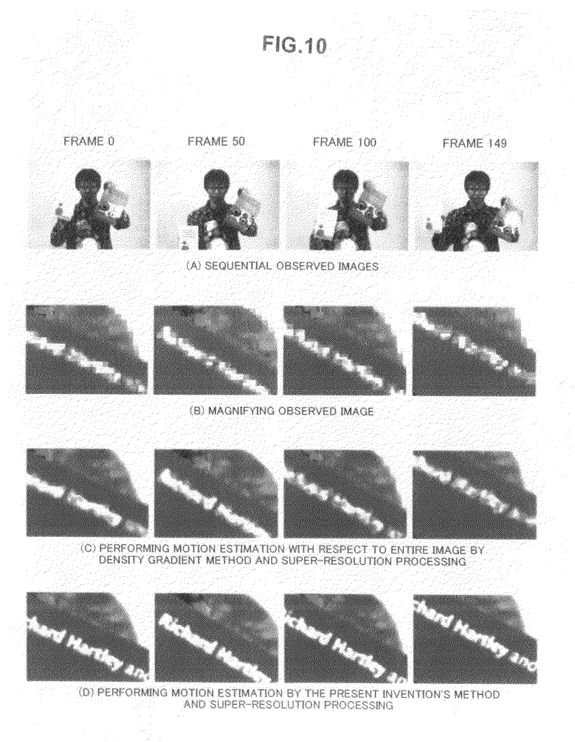

FIG. 9 and FIG. 10 show results of the super-resolution processing with respect to sequential images obtained by photographing more complicated scenes. The scenes (the sequential images) are moving images that a person freely moves two books. The two books that are two planes separately move, and the face and clothes that are nonplanar also freely move. Further, illumination changes that include occlusions and specular reflection components occur. As to such scenes, the super-resolution processing is performed with respect to all frames of the moving images.

By using the motion parameter estimated by the present invention, the super-resolution processing is performed. Further, for comparison, the super-resolution processing is also performed by using the motion parameter that is estimated with respect to the entire image by the density gradient method. In the density gradient method, as the motion, a planar projective transformation is assumed. FIG. 9 and FIG. 10 correspond to frame 0, frame 50, frame 100 and frame 149, from the left column sequentially. FIG. 9(B), (C) and (D) are images obtained by manually capturing a region where glasses are included in. FIG. 10(B), (C) and (D) are images obtained by manually capturing a region where a blue book is included in. Regions are set respectively for each frame, both the present invention and the existing method capture the same region from the observed images.

By comparison with FIG. 9(B), (C) and (D), it is clear that in the edge of glasses, the super-resolution processing results using the registration result according to the present invention have the highest feeling of definition, and color deviations are also suppressed. By comparison with FIG. 10(B), (C) and (D), it is clear that characters that are unreadable in both the observed images that are magnified and the super-resolution processing results using the motion estimation result of the entire image according to the density gradient method, become readable by the super-resolution processing using the registration result according to the present invention.

With respect to moving images (sequential observed images) such as FIG. 9(A), in the case of performing the super-resolution processing with respect to a specific region in a specific frame, a method that specifies the processing region and estimates the motion parameter by the density gradient method is also useful. However, in the case that targets of the super-resolution processing are all frames of moving images, an operation such as specifying the processing region with respect to all frames is unrealistic.

On the other hand, in the case of using the registration result according to the present invention, it is possible to perform the super-resolution processing with respect to the entire image of all frames without requiring an operation such as specifying the processing region.

In the first embodiment of the image quality improvement processing apparatus according to the present invention described above, the single-motion region extraction processing extracts the single-motion region based on the similarity and the local displacement between images.

Incidentally, when estimating the local displacement, in a textureless region, the local displacement estimation easily becomes unstable. Therefore, a processing that determines the textureless region and makes the single-motion region not including the textureless region is performed.

Therefore, as an intensively-studied result with respect to the textureless region, the inventors of the present invention found that even in the case of the textureless region, if a local similarity such as an SSD is high, a textureless region with a high local similarity can be used in the image quality improvement processing.

That is to say, in the second embodiment of the image quality improvement processing apparatus according to the present invention, by adding a region that is both a textureless region and a similar region (hereinafter, such a region is simply also referred to as “a textureless similar region”) to the single-motion region, and by performing the image quality improvement processing, the improvement of signal-to-noise ration of the textureless region is realized.

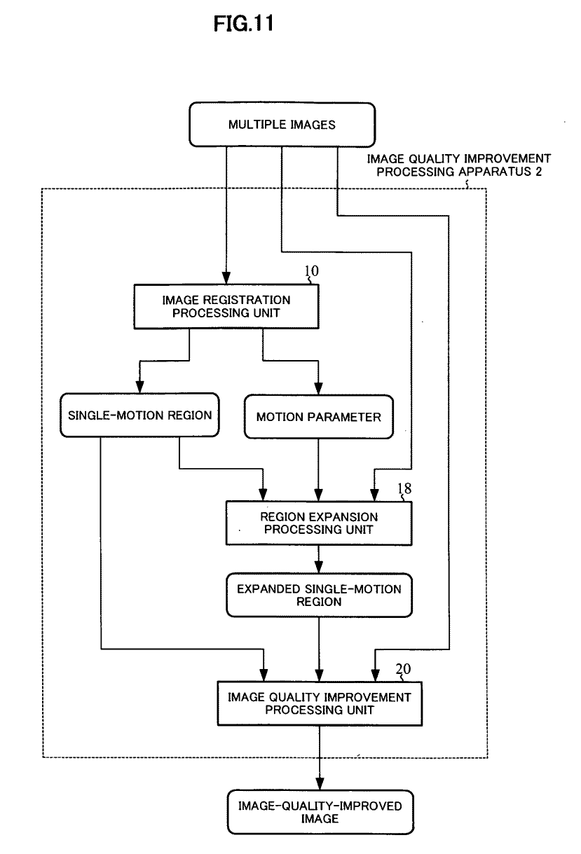

FIG. 11 is a block diagram illustrating the second embodiment of the image quality improvement'processing apparatus according to the present invention (an image quality improvement processing apparatus 2 according to the present invention).

As shown in FIG. 11, the image quality improvement processing apparatus 2 according to the present invention comprises an image registration processing unit 10, a region expansion processing unit 18 and an image quality improvement processing unit 20, and generates an image-quality-improved image with high image quality based on multiple images including multiple motions.

In the image quality improvement processing apparatus 2 of the present invention, at first, the image registration processing unit 10 selects one basis image from multiple images and sets all the remaining images as input images. Next, the image registration processing unit 10 extracts all single-motion regions within multiple images including multiple motions by iteratively performing the registration processing of the entire image between one basis image and one input image that is performed by the above-described image registration processing apparatus according to the present invention with respect to multiple images, and then robustly estimates all motion parameters corresponding to all single-motion regions with high accuracy.

Moreover, since a concrete processing flow (an operational flow) of the image registration processing unit 10 of the image quality improvement processing apparatus 2 according to the present invention, is the same as the processing flow of the image registration processing unit 10 of the image quality improvement processing apparatus 11 according to the present invention, that description is omitted.

Next, based on all single-motion regions in multiple images and all motion parameters corresponding to all single-motion regions that are outputted from the image registration processing unit 10, the region expansion processing unit 18 generates all expanded single-motion regions in multiple images by iteratively performing a region expansion processing with respect to one basis image and one input image that is performed in a region expansion processing apparatus according to the present invention that will hereinafter be described in detail with respect to multiple images.

Next, the image quality improvement processing unit 20 generates the image-quality-improved image by performing the image quality improvement processing with respect to multiple images including multiple motions based on all expanded single-motion regions in multiple images that are outputted from the region expansion processing unit 18 and all motion parameters that are outputted from the image registration processing unit 10. Further, it is possible to perform the image quality improvement processing that is performed in the image quality improvement processing unit 20 by using a method such as an image quality improvement processing method disclosed in Patent Document 3.

Moreover, as multiple images including multiple motions that are used in the image quality improvement processing apparatus 2 according to the present invention, it is possible to use moving images with multiple motions (multiple complicated motions), that is, sequential images obtained by photographing scenes that multiple moving objects move separately. In such case, for example, it is possible to set the first frame of the sequential images as the basis image and set the subsequent frames as input images.

Of course, the image quality improvement processing apparatus 2 according to the present invention is not limited to being applied to moving images, obviously, it is also possible to use still images as multiple images including multiple motions.

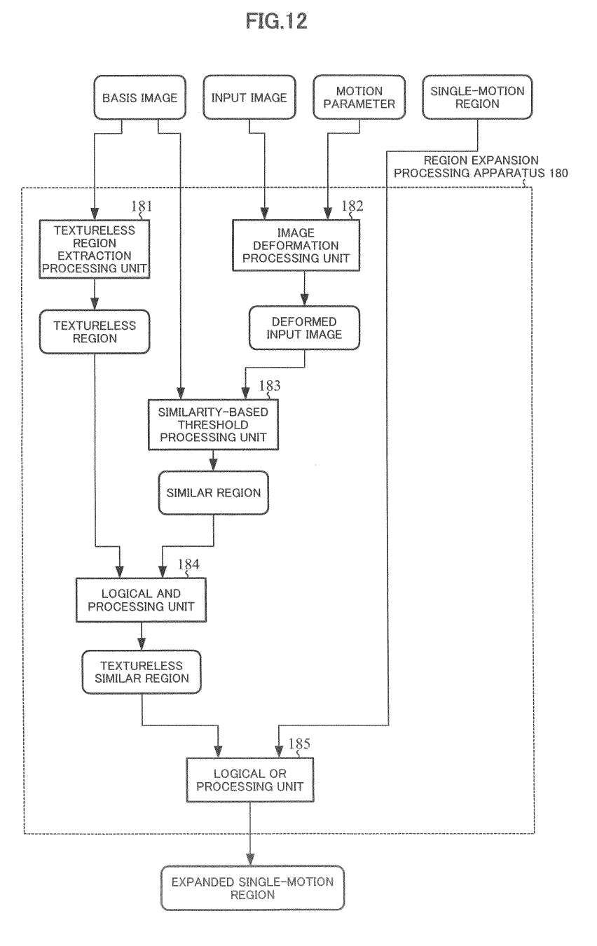

FIG. 12 is a block diagram illustrating an embodiment of the region expansion processing apparatus according to the present invention (a region expansion processing apparatus 180). Hereinafter, the region expansion processing apparatus according to the present invention will be described in detail with reference to FIG. 12.

A processing performed in the region expansion processing apparatus according to the present invention is the region expansion processing that is performed with respect to the basis image and the input image based on the basis image including multiple motions, the input image including multiple motions, and multiple single-motion regions corresponding to multiple motions and multiple motion parameters corresponding to multiple single-motion regions that are obtained by performing the registration processing of the entire image between the basis image and the input image.

Multiple single-motion regions corresponding to multiple motions and multiple motion parameters corresponding to multiple single-motion regions that are utilized in the region expansion processing apparatus according to the present invention, are single-motion regions and motion parameters that are obtained by the registration processing of the entire image performed in the image registration processing apparatus according to the present invention.

As shown in FIG. 12, the region expansion processing apparatus 180 of the present invention comprises a textureless region extraction processing unit 181 that inputs the basis image, an image deformation processing unit 182 that inputs the input image and multiple motion parameters, a similarity-based threshold processing unit 183 that inputs the basis image as an input, a logical AND processing unit 184 and a logical OR processing unit 185 that inputs multiple single-motion regions.

In the region, expansion processing apparatus 180 of the present invention, at first, the textureless region extraction processing unit 181 performs a textureless region extraction processing that extracts a textureless region within the basis image, and outputs the extracted textureless region to the logical AND processing unit 184.

Next, the image deformation processing unit 182 deforms the input image based on multiple motion parameters, and outputs the input image that is deformed to the similarity-based threshold processing unit 183 as a deformed input image.

And then, the similarity-based threshold processing unit 183 extracts a similar region by performing a threshold processing for a local similarity with respect to the basis image and the deformed input image, and outputs the extracted similar region to the logical AND processing unit 184.

Next, the logical AND processing unit 184 generates a textureless similar region by performing a logical AND processing with respect to the textureless region outputted from the textureless region extraction processing unit 181 and the similar region outputted from the similarity-based threshold processing unit 183, and outputs the generated textureless similar region to the logical OR processing unit 185.

Finally, the logical OR processing unit 185 generates multiple expanded single-motion regions that merge the textureless similar region and multiple single-motion regions by performing a logical OR processing with respect to the textureless similar region outputted from the logical AND processing unit 184 and multiple single-motion regions.

The textureless region extraction processing performed in the textureless region extraction processing unit 181 can utilize existing methods. As a concrete example of the textureless region extraction processing, for example, there is a method that obtains a local image variance of the basis image and extracts a region that the obtained local image variance is less than or equal to a given threshold as a textureless region.

Further, the local similarity used in the similarity-based threshold processing unit 183 can utilize existing similarities. As concrete examples, for example, it is possible to use an SSD (Sum of Squared Difference) or an SAD (Sum of Absolute Difference).

Since the above-described image quality improvement processing apparatus 2 according to the present invention performs the image quality improvement processing based on the expanded single-motion regions. obtained by adding the textureless similar region to the single-motion regions, an advantageous effect that it is possible to realize the improvement of signal-to-noise ration of the textureless region can be achieved.

Moreover, the region expansion processing apparatus and the image quality improvement processing apparatus according to the present invention described above, can be implemented by using a computer system and software (computer programs), and then, of course can also be implemented by hardware such as an ASIC (Application Specific Integrated Circuit), a GPU (Graphics Processing Unit) and an FPGA (Field Programmable Gate Array).

### EXPLANATION OF REFERENCE NUMERALS

1,2 image quality improvement processing apparatus
10 image registration processing unit
18 region expansion processing unit
20 image quality improvement processing unit
100 image registration processing apparatus
110 feature point extraction processing unit
120 feature point-based registration processing unit
130 single-motion region extraction processing unit
140 region-based registration processing unit
150 feature point deletion processing unit
180 region expansion processing apparatus
181 textureless region extraction processing unit
182 image deformation processing unit
183 similarity-based threshold processing unit
184 logical AND processing unit
185 logical OR processing unit

1. An image registration processing apparatus for performing a robust and high-accuracy registration processing of an entire image between a basis image including multiple motions and an input image including multiple motions, comprising:
a feature point extraction processing unit;
a feature point-based registration processing unit;
a single-motion region extraction processing unit;
a region-based registration processing unit; and
a feature point deletion processing unit,
wherein
said feature point extraction processing unit performs a feature point extraction processing that extracts feature points of said basis image and said input image respectively,
said feature point-based registration processing unit performs a feature point-based registration processing that is comprised of a matching processing between feature points extracted from said basis image (basis image feature points) and feature points extracted from said input image (input image feature points) and an initial motion parameter estimation processing after deleting outliers from matched feature points,
said single-motion region extraction processing unit performs a single-motion region extraction processing that extracts a single-motion region corresponding to an initial motion parameter outputted from said feature point-based registration processing unit based on said initial motion parameter and by using a similarity and a local displacement between images,
said region-based registration processing unit performs a region-based registration processing that estimates a motion parameter corresponding to said single-motion region outputted from said single-motion region extraction processing unit with subpixel accuracy based on said initial motion parameter outputted from said feature point-based registration processing unit and said single-motion region,
said feature point deletion processing unit performs a feature point deletion processing that deletes feature points included in said single-motion region extracted by said single-motion region extraction processing unit from said basis image feature points and said input image feature points.

2. An image registration processing apparatus according to claim 1, wherein
by sequentially performing a processing performed in said feature point extraction processing unit, a processing performed in said feature point-based registration processing unit, a processing performed in said single-motion region extraction processing unit and a processing performed in said region-based registration processing unit based on said basis image and said input image, said image registration processing apparatus extracts a first single-motion region corresponding to a first dominant motion by using all feature points extracted by said feature point extraction processing unit, and estimates a first motion parameter corresponding to extracted said first single-motion region.

3. An image registration processing apparatus according to claim 2, wherein
after said first motion parameter is estimated, by setting remaining feature points that are not deleted by said feature point deletion processing performed in said feature point deletion processing unit as said basis image feature points and said input image feature points that are used in said feature point-based registration processing performed in said feature point-based registration processing unit, and then once again sequentially performing said processing performed in said feature point-based registration processing unit, said processing performed in said single-motion region extraction processing unit and said processing performed in said region-based registration processing unit, said image registration processing apparatus extracts a second single-motion region corresponding to a second dominant motion, and estimates a second motion parameter corresponding to extracted said second single-motion region.

4. An image registration processing apparatus according to claim 3, wherein
after said second motion parameter is estimated, said image registration processing apparatus sequentially extracts all single-motion regions corresponding to multiple motions and then sequentially estimates motion parameters corresponding to all sequentially-extracted single-motion regions by iteratively performing said processing performed in said feature point-based registration processing unit, said processing performed in said single-motion region extraction processing unit and said processing performed in said region-based registration processing unit, while removing feature points included in said single-motion region by said processing performed in said feature point deletion processing unit.

5. An image registration processing apparatus for performing a robust and high-accuracy registration processing of an entire image between a basis image including multiple motions and an input image including multiple motions, comprising:
a feature point extraction processing unit;
a feature point-based registration processing unit;
a single-motion region extraction processing unit; and
a region-based registration processing unit,
wherein
said feature point extraction processing unit performs a feature point extraction processing that extracts feature points of said basis image and said input image respectively,
said feature point-based registration processing unit performs a feature point-based registration processing that is comprised of a matching processing between feature points extracted from said basis image (basis image feature points) and feature points extracted from said input image (input image feature points) and an initial motion parameter estimation processing after deleting outliers from matched feature points,
said single-motion region extraction processing unit performs a single-motion region extraction processing that extracts a single-motion region corresponding to an initial motion parameter outputted from said feature point-based registration processing unit based on said initial motion parameter and by using a similarity and a local displacement between images,
said region-based registration processing unit performs a region-based registration processing that estimates a motion parameter corresponding to said single-motion region outputted from said single-motion region extraction processing unit with subpixel accuracy based on said initial motion parameter outputted from said feature point-based registration processing unit and said single-motion region.

6. An image registration processing apparatus according to claim 5, wherein
by sequentially performing a processing performed in said feature point extraction processing unit, a processing performed in said feature point-based registration processing unit, a processing performed in said single-motion region extraction processing unit and a processing performed in said region-based registration processing unit based on said basis image and said input image, said image registration processing apparatus extracts a first single-motion region corresponding to a first dominant motion by using all feature points extracted by said feature point extraction processing unit, and estimates a first motion parameter corresponding to extracted said first single-motion region.

7. An image registration processing method for performing a robust and high-accuracy registration processing of an entire image between a basis image including multiple motions and an input image including multiple motions, comprising:
a feature point extraction processing step;
a feature point-based registration processing step;
a single-motion region extraction processing step;
a region-based registration processing step; and
a feature point deletion processing step,
wherein
said feature point extraction processing step performs a feature point extraction processing that extracts feature points of said basis image and said input image respectively,
said feature point-based registration processing step performs a feature point-based registration processing that is comprised of a matching processing between feature points extracted from said basis image (basis image feature points) and feature points extracted from said input image (input image feature points) and an initial motion parameter estimation processing after deleting outliers from matched feature points,
said single-motion region extraction processing step performs a single-motion region extraction processing that extracts a single-motion region corresponding to an initial motion parameter estimated in said feature point-based registration processing step based on said initial motion parameter and by using a similarity and a local displacement between images,
said region-based registration processing step performs a region-based registration processing that estimates a motion parameter corresponding to said single-motion region extracted in said single-motion region extraction processing step with subpixel accuracy based on said initial motion parameter estimated in said feature point-based registration processing step and said single-motion region,
said feature point deletion processing step performs a feature point deletion processing that deletes feature points included in said single-motion region extracted in said single-motion region extraction processing step from said basis image feature points and said input image feature points.

8. An image registration processing method according to claim 7, wherein
by sequentially performing a processing performed in said feature point extraction processing step, a processing performed in said feature point-based registration processing step, a processing performed in said single-motion region extraction processing step and a processing performed in said region-based registration processing step based on said basis image and said input image, said image registration processing method extracts a first single-motion region corresponding to a first dominant motion by using all feature points extracted in said feature point extraction processing step, and estimates a first motion parameter corresponding to extracted said first single-motion region.

9. An image registration processing method according to claim 8, wherein
after said first motion parameter is estimated, by setting remaining feature points that are not deleted by said feature point deletion processing performed in said feature point deletion processing step as said basis image feature points and said input image feature points that are used in said feature point-based registration processing performed in said feature point-based registration processing step, and then once again sequentially performing said processing performed in said feature point-based registration processing step, said processing performed in said single-motion region extraction processing step and said processing performed in said region-based registration processing step, said image registration processing method extracts a second single-motion region corresponding to a second dominant motion, and estimates a second motion parameter corresponding to extracted said second single-motion region.

10. An image registration processing method according to claim 9, wherein
after said second motion parameter is estimated, said image registration processing method sequentially extracts all single-motion regions corresponding to multiple motions and then sequentially estimates motion parameters corresponding to all sequentially-extracted single-motion regions by iteratively performing said processing performed in said feature point-based registration processing step, said processing performed in said single-motion region extraction processing step and said processing performed in said region-based registration processing step, while removing feature points included in said single-motion region by said processing performed in said feature point deletion processing step.

11. An image registration processing method for performing a robust and high-accuracy registration processing of an entire image between a basis image including multiple motions and an input image including multiple motions, comprising:
a feature point extraction processing step;
a feature point-based registration processing step;
a single-motion region extraction processing step; and
a region-based registration processing step,
wherein
said feature point extraction processing step performs a feature point extraction processing that extracts feature points of said basis image and said input image respectively,
said feature point-based registration processing step performs a feature point-based registration processing that is comprised of a matching processing between feature points extracted from said basis image (basis image feature points) and feature points extracted from said input image (input image feature points) and an initial motion parameter estimation processing after deleting outliers from matched feature points,
said single-motion region extraction processing step performs a single-motion region extraction processing that extracts a single-motion region corresponding to an initial motion parameter estimated in said feature point-based registration processing step based on said initial motion parameter and by using a similarity and a local displacement between images,
said region-based registration processing step performs a region-based registration processing that estimates a motion parameter corresponding to said single-motion region extracted in said single-motion region extraction processing step with subpixel accuracy based on said initial motion parameter estimated in said feature point-based registration processing step and said single-motion region.

12. An image registration processing method according to claim 11, wherein
by sequentially performing a processing performed in said feature point extraction processing step, a processing performed in said feature point-based registration processing step, a processing performed in said single-motion region extraction processing step and a processing performed in said region-based registration processing step based on said basis image and said input image, said image registration processing method extracts a first single-motion region corresponding to a first dominant motion by using all feature points extracted in said feature point extraction processing step, and estimates a first motion parameter corresponding to extracted said first single-motion region.

13. A computer-readable media having computer-executable instructions embodied thereon for performing an image registration processing method for performing a robust and high-accuracy registration processing of an entire image between a basis image including multiple motions and an input image including multiple motions, said image registration processing method comprising:
a feature point extraction processing step;
a feature point-based registration processing step;
a single-motion region extraction processing step;
a region-based registration processing step; and
a feature point deletion processing step,
wherein
said feature point extraction processing step performs a feature point extraction processing that extracts feature points of said basis image and said input image respectively,
said feature point-based registration processing step performs a feature point-based registration processing that is comprised of a matching processing between feature points extracted from said basis image (basis image feature points) and feature points extracted from said input image (input image feature points) and an initial motion parameter estimation processing after deleting outliers from matched feature points,
said single-motion region extraction processing step performs a single-motion region extraction processing that extracts a single-motion region corresponding to an initial motion parameter estimated in said feature point-based registration processing step based on said initial motion parameter and by using a similarity and a local displacement between images,
said region-based registration processing step performs a region-based registration processing that estimates a motion parameter corresponding to said single-motion region extracted in said single-motion region extraction processing step with subpixel accuracy based on said initial motion parameter estimated in said feature point-based registration processing step and said single-motion region,
said feature point deletion processing step performs a feature point deletion processing that deletes feature points included in said single-motion region extracted in said single-motion region extraction processing step from said basis image feature points and said input image feature points.

14. A computer-readable media according to claim 13, wherein
by sequentially performing a processing performed in said feature point extraction processing step, a processing performed in said feature point-based registration processing step, a processing performed in said single-motion region extraction processing step and a processing performed in said region-based registration processing step based on said basis image and said input image, said image registration processing method extracts a first single-motion region corresponding to a first dominant motion by using all feature points extracted in said feature point extraction processing step, and estimates a first motion parameter corresponding to extracted said first single-motion region.

15. A computer-readable media according to claim 14, wherein
after said first motion parameter is estimated, by setting remaining feature points that are not deleted by said feature point deletion processing performed in said feature point deletion processing step as said basis image feature points and said input image feature points that are used in said feature point-based registration processing performed in said feature point-based registration processing step, and then once again sequentially performing said processing performed in said feature point-based registration processing step, said processing performed in said single-motion region extraction processing step and said processing performed in said region-based registration processing step, said image registration processing method extracts a second single-motion region corresponding to a second dominant motion, and estimates a second motion parameter corresponding to extracted said second single-motion region.

16. A computer-readable media according to claim 15, wherein
after said second motion parameter is estimated, said image registration processing method sequentially extracts all single-motion regions corresponding to multiple motions and then sequentially estimates motion parameters corresponding to all sequentially-extracted single-motion regions by iteratively performing said processing performed in said feature point-based registration processing step, said processing performed in said single-motion region extraction processing step and said processing performed in said region-based registration processing step, while removing feature points included in said single-motion region by said processing performed in said feature point deletion processing step.

17. A computer-readable media having computer-executable instructions embodied thereon for performing an image registration processing method for performing a robust and high-accuracy registration processing of an entire image between a basis image including multiple motions and an input image including multiple motions, said image registration processing method comprising:
a feature point extraction processing step;
a feature point-based registration processing step;
a single-motion region extraction processing step; and
a region-based registration processing step,
wherein
said feature point extraction processing step performs a feature point extraction processing that extracts feature points of said basis image and said input image respectively,
said feature point-based registration processing step performs a feature point-based registration processing that is comprised of a matching processing between feature points extracted from said basis image (basis image feature points) and feature points extracted from said input image (input image feature points) and an initial motion parameter estimation processing after deleting outliers from matched feature points,
said single-motion region extraction processing step performs a single-motion region extraction processing that extracts a single-motion region corresponding to an initial motion parameter estimated in said feature point-based registration processing step based on said initial motion parameter and by using a similarity and a local displacement between images,
said region-based registration processing step performs a region-based registration processing that estimates a motion parameter corresponding to said single-motion region extracted in said single-motion region extraction processing step with subpixel accuracy based on said initial motion parameter estimated in said feature point-based registration processing step and said single-motion region.

18. A computer-readable media according to claim 17, wherein
by sequentially performing a processing performed in said feature point extraction processing step, a processing performed in said feature point-based registration processing step, a processing performed in said single-motion region extraction processing step and a processing performed in said region-based registration processing step based on said basis image and said input image, said image registration processing method extracts a first single-motion region corresponding to a first dominant motion by using all feature points extracted in said feature point extraction processing step, and estimates a first motion parameter corresponding to extracted said first single-motion region.

19. An image quality improvement processing apparatus for generating an image-quality-improved image with high image quality based on multiple images including multiple motions, comprising:
an image registration processing unit; and
an image quality improvement processing unit,
wherein
said image registration processing unit selects one basis image from said multiple images and sets all the remaining images as input images, next, extracts all single-motion regions within said multiple images including multiple motions by iteratively performing a registration processing of an entire image between one basis image and one input image that is performed by an image registration processing apparatus according to claim 1 with respect to said multiple images, and then robustly estimates all motion parameters corresponding to said all single-motion regions with high accuracy,
said image quality improvement processing unit generates said image-quality-improved image by performing an image quality improvement processing with respect to said multiple images based on multiple single-motion regions and multiple motion parameters corresponding to said multiple single-motion regions that are outputted from said image registration processing unit.

20. A region expansion processing apparatus for performing a region expansion processing that is performed with respect to a basis image including multiple motions and an input image including multiple motions based on said basis image, said input image, and multiple single-motion regions corresponding to multiple motions and multiple motion parameters corresponding to said multiple single-motion regions that are obtained by performing a registration processing of an entire image between said basis image and said input image, comprising:
a textureless region extraction processing unit that inputs said basis image;
an image deformation processing unit that inputs said input image and said multiple motion parameters;
a similarity-based threshold processing unit that inputs said basis image as an input;
a logical AND processing unit; and
a logical OR processing unit that inputs said multiple single-motion regions,
wherein
said textureless region extraction processing unit performs a textureless region extraction processing that extracts a textureless region within said basis image and outputs extracted textureless region to said logical AND processing unit,
said image deformation processing unit deforms said input image based on said multiple motion parameters and outputs said input image that is deformed to said similarity-based threshold processing unit as a deformed input image,
said similarity-based threshold processing unit extracts a similar region by performing a threshold processing for a local similarity with respect to said basis image and said deformed input image and outputs extracted similar region to said logical AND processing unit,
said logical AND processing unit generates a textureless similar region by performing a logical AND processing with respect to said textureless region outputted from said textureless region extraction processing unit and said similar region outputted from said similarity-based threshold processing unit and outputs generated textureless similar region to said logical OR processing unit,
said logical OR processing unit generates multiple expanded single-motion regions that merge said textureless similar region and said multiple single-motion regions by performing a logical OR processing with respect to said textureless similar region outputted from said logical AND processing unit and said multiple single-motion regions.

21. A region expansion processing apparatus according to claim 20, wherein
said textureless region extraction processing obtains a local image variance of said basis image and extracts a region that obtained local image variance is less than or equal to a given threshold as a textureless region.

22. A region expansion processing apparatus according to claim 20, wherein
said local similarity used in said similarity-based threshold processing unit is an SSD (Sum of Squared Difference) or an SAD (Sum of Absolute Difference).

23. An image quality improvement processing apparatus for generating an image-quality-improved image with high image quality based on multiple images including multiple motions, comprising:
an image registration processing unit;
a region expansion processing unit; and
an image quality improvement processing unit,
wherein
said image registration processing unit selects one basis image from said multiple images and sets all the remaining images as input images, next, extracts all single-motion regions within said multiple images including multiple motions by iteratively performing a registration processing of an entire image between one basis image and one input image that is performed by an image registration processing apparatus according to claim 1 with respect to said multiple images, and then robustly estimates all motion parameters corresponding to said all single-motion regions with high accuracy,
based on all single-motion regions in said multiple images and all motion parameters corresponding to said all single-motion regions that are outputted from said image registration processing unit, said region expansion processing unit generates all expanded single-motion regions in said multiple images by iteratively performing a region expansion processing with respect to one basis image and one input image that is performed in a region expansion processing apparatus according to claim 20 with respect to said multiple images,
said image quality improvement processing unit generates said image-quality-improved image by performing an image quality improvement processing with respect to said multiple images based on all expanded single-motion regions in said multiple images that are outputted from said region expansion processing unit and said all motion parameters that are outputted from said image registration processing unit.

24. A region expansion processing method for performing a region expansion processing that is performed with respect to a basis image including multiple motions and an input image including multiple motions based on said basis image, said input image, and multiple single-motion regions corresponding to multiple motions and multiple motion parameters corresponding to said multiple single-motion regions that are obtained by performing a registration processing of an entire image between said basis image and said input image, comprising:
a textureless region extraction processing step that inputs said basis image;
an image deformation processing step that inputs said input image and said multiple motion parameters;
a similarity-based threshold processing step that inputs said basis image as an input;
a logical AND processing step; and
a logical OR processing step that inputs said multiple single-motion regions,
wherein
said textureless region extraction processing step performs a textureless region extraction processing that extracts a textureless region within said basis image,
said image deformation processing step deforms said input image based on said multiple motion parameters and sets said input image that is deformed as a deformed input image,
said similarity-based threshold processing step extracts a similar region by performing a threshold processing for a local similarity with respect to said basis image and said deformed input image,
said logical AND processing step generates a textureless similar region by performing a logical AND processing with respect to said textureless region extracted in said textureless region extraction processing step and said similar region extracted in said similarity-based threshold processing step,
said logical OR processing step generates multiple expanded single-motion regions that merge said textureless similar region and said multiple single-motion regions by performing a logical OR processing with respect to said textureless similar region generated in said logical AND processing step and said multiple single-motion regions.

25. A region expansion processing method according to claim 24, wherein
said textureless region extraction processing obtains a local image variance of said basis image and extracts a region that obtained local image variance is less than or equal to a given threshold as a textureless region.

26. A region expansion processing method according to claim 24, wherein
said local similarity used in said similarity-based threshold processing step is an SSD (Sum of Squared Difference) or an SAD (Sum of Absolute Difference).
